(19) United States
(12) Patent Application Publication
(10) Pub. No.: US 2005/0132658 A1
(43) Pub. Date: Jun. 23, 2005

(54) Method of making abrasive particles

(75) Inventors: Ahmet Celikkaya, Woodbury, MN (US); Thomas J. Anderson, Woodbury, MN (US); Donna W. Bange, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/740,096

(22) Filed: Dec. 18, 2003

(51) Int. Cl. C09K 3/14; B24D 3/00

(52) U.S. Cl. 51/307; 51/308; 501/127; 51/309; 51/298; 51/295; 51/297; 51/293

(57) ABSTRACT

Methods for making fused, polycrystalline ceramic abrasive particles. Fused, polycrystalline ceramic abrasive particles made according to the present invention are useful, for example, as abrasive particles in abrasive articles.

### BACKGROUND

There are a variety of abrasive particles (e.g., diamond particles, cubic boron nitride particles, fused abrasive particles, and sintered, ceramic abrasive particles (including sol-gel-derived abrasive particles)) known in the art. In some abrading applications, the abrasive particles are used in loose form, while in others the particles are incorporated into abrasive products (e.g., coated abrasive products, bonded abrasive products, non-woven abrasive products, and abrasive brushes). Criteria used in selecting abrasive particles used for a particular abrading application include: abrading life, rate of cut, substrate surface finish, grinding efficiency, and product cost.

From about 1900 to about the mid-1980's, the popular abrasive particles for abrading applications such as those utilizing coated and bonded abrasive products were typically fused abrasive particles. There are two common types of fused abrasive particles: (1) fused alpha alumina abrasive particles (see, e.g., U.S. Pat. No. 1,161,620 (Coulter), U.S. Pat. No. 1,192,709 (Tone), U.S. Pat. No. 1,247,337 (Saunders et al.), U.S. Pat. No. 1,268,533 (Allen), and U.S. Pat. No. 2,424,645 (Baumann et al.)), and (2) fused (sometimes also referred to as “co-fused”) alumina-zirconia abrasive particles (see, e.g., U.S. Pat. No. 3,891,408 (Rowse et al.), U.S. Pat. No. 3,781,172 (Pett et al.), U.S. Pat. No. 3,893,826 (Quinan et al.), U.S. Pat. No. 4,126,429 (Watson), U.S. Pat. No. 4,457,767 (Poon et al.), and U.S. Pat. No. 5,143,522 (Gibson et al.)) (also see, e.g., U.S. Pat. No. 5,023,212 (Dubots et al.), and U.S. Pat. No. 5,336,280 (Dubots et al.) which report certain fused oxynitride abrasive particles). Fused alumina abrasive particles are typically made by charging a furnace with an alumina source such as aluminum ore or bauxite, as well as other incidental impurities and desired additives, heating the material above its melting point, cooling the melt to provide a solidified mass, crushing the solidified mass into particles, and then screening and grading the particles to provide the desired abrasive particle size distribution. Fused alumina-zirconia abrasive particles are typically made in a similar manner, except the furnace is charged with an alumina source, a zirconia source, and optionally some stabilizing oxides such as yttria, ceria, magnesia, rare earth oxides, and titania, and the melt is more rapidly cooled than the melt used to make fused alumina abrasive particles. For fused alumina-zirconia abrasive particles, the amount of alumina source is typically about 15-85 percent by weight, and the amount of zirconia, about 85-15 percent by weight. The processes for making the fused alumina and fused alumina abrasive particles typically includes removal of impurities from the melt prior to the cooling step.

The residual impurities (e.g., silica, titania, and iron oxides) are generally concentrated at the boundaries of crystals and eutectic cells. The impurities at the crystal and/or cell boundaries may be present in crystalline and/or glassy states, and/or in a dissolved state in the crystal structure of, for example, the alumina and/or zirconia. A common impurity in fused alumina-zirconia ceramics made via arc melting processes is carbon. Although not wanting to be bound by theory, it is believed that carbon detrimentally effect the alumina-zirconia ceramics if such ceramics are sufficiently heated (e.g., generally above about 350° C.) in an oxidizing atmosphere.

In general, it is known that the cooling rate affects the morphology (e.g., size) of the eutectic cells containing eutectic laminar structures, and the spacing between the eutectic laminae (i.e., the thickness of the laminae). Further, in general, it is known that higher cooling rates typically lead to smaller eutectic cells and thinner eutectic laminae. Also, in general, it is known that the cooling rate may affect the phase constituency of the resulting ceramic. For example, the higher cooling rates typically preferentially produce more tetragonal (cubic) zirconia. Generally, in the absence of any stabilizers (such as yttria, magnesia, etc.), the smaller tetragonal zirconia crystals are more stable against transformation to a monoclinic phase. Additionally, if the heat removal from the melt is done in a directional manner (e.g., in the case of book molds), the cells containing the eutectic structures may grow asymmetrically in the direction of heat removal (i.e., the cell growth may become oriented or elongated). Typically, smaller cell sizes are more desirable.

Recent developments in the area of fused abrasive particles include those reported, for example, in PCT applications having publication Nos. WO01/56945, WO01/56946, WO01/56947, WO01/56948, WO01/56949, WO01/56950, published Aug. 9, 2001, and WO02/08143, WO02/08144, WO02/08145, WO02/08146, published Jan. 31, 2002.

Although fused alpha alumina abrasive particles and fused alumina-zirconia abrasive particles are still widely used in abrading applications (including those utilizing coated and bonded abrasive products), the premier abrasive particles for many abrading applications since about the mid-1980's are sol-gel-derived alpha alumina particles (see, e.g., U.S. Pat. No. 4,314,827 (Leitheiser et al.), U.S. Pat. No. 4,518,397 (Leitheiser et al.), U.S. Pat. No. 4,623,364 (Cottringer et al.), U.S. Pat. No. 4,744,802 (Schwabel), U.S. Pat. No. 4,770,671 (Monroe et al.), U.S. Pat. No. 4,881,951 (Wood et al.), U.S. Pat. No. 4,960,441 (Pellow et al.), U.S. Pat. No. 5,139,978 (Wood), U.S. Pat. No. 5,201,916 (Berg et al.), U.S. Pat. No. 5,366,523 (Rowenhorst et al.), U.S. Pat. No. 5,429,647 (Larmie), U.S. Pat. No. 5,547,479 (Conwell et al.), U.S. Pat. No. 5,498,269 (Larmie), U.S. Pat. No. 5,551,963 (Larmie), and U.S. Pat. No. 5,725,162 (Garg et al.)).

The sol-gel-derived alpha alumina abrasive particles may have a microstructure made up of very fine alpha alumina crystallites, with or without the presence of secondary phases added. The grinding performance of the sol-gel-derived abrasive particles on metal, as measured, for example, by life of abrasive products made with the abrasive particles was dramatically longer than such products made from many conventional fused alumina abrasive particles.

There are a variety of abrasive products (also referred to “abrasive articles”) known in the art. Typically, abrasive products include binder and abrasive particles secured within the abrasive product by the binder. Examples of abrasive products include: coated abrasive products, bonded abrasive products, nonwoven abrasive products, and abrasive brushes.

Examples of bonded abrasive products include: grinding wheels, cutoff wheels, and honing stones. The main types of bonding systems used to make bonded abrasive products are: resinoid, vitrified, and metal. Resinoid bonded abrasives utilize an organic binder system (e.g., phenolic binder systems) to bond the abrasive particles together to form the shaped mass (see, e.g., U.S. Pat. No. 4,741,743 (Narayanan et al.), U.S. Pat. No. 4,800,685 (Haynes et al.), U.S. Pat. No. 5,038,453 (Narayanan et al.), and U.S. Pat. No. 5,110,332 (Narayanan et al.)). Another major type are vitrified wheels in which a glass binder system is used to bond the abrasive particles together into a mass (see, e.g., U.S. Pat. No. 4,543,107 (Rue), U.S. Pat. No. 4,898,587 (Hay et al.), U.S. Pat. No. 4,997,461 (Markhoff Matheny et al.), and U.S. Pat. No. 5,863,308 (Qi et al.)). These glass bonds are usually matured at temperatures between 900° C. to 1300° C. Today vitrified wheels utilize both fused alumina and sol-gel-derived abrasive particles. Metal bonded abrasive products typically utilize sintered or plated metal to bond the abrasive particles.

The abrasive industry continues to desire for new abrasive particles and abrasive articles, as well as methods for making the same.

### SUMMARY

The present invention provides methods for making a plurality of fused, polycrystalline ceramic abrasive particles. In one exemplary method according to the present invention for making a plurality of fused, polycrystalline ceramic abrasive particles, the method comprising:

melting a first plurality of particles to form melt (e.g., flame forming a melt) droplets, wherein the first plurality of particles collectively provide at least 35 (in some embodiments, at least 40, 45, 50, 55, 60, 65, 70, 75, 80, 85, 90, 95, 99, or even at least 99.9) percent by weight Al₂O₃ collectively in the melt droplets, based on the total weight of the melt droplets, wherein the melt droplets collectively comprise a first composition; and

cooling the melt droplets to directly provide a second plurality of particles, wherein the second plurality of particles collectively have a second composition, wherein the second composition is in a range from 75 to 125 (in:some embodiments, in a range 80 to 120, 85 to 115, or even in a range 90 to 110) percent by weight of the first composition, wherein at least 75 (in some embodiments, at least 80, 85, 90, 95, or even 100) percent by number of the second plurality of particles are fused, polycrystalline ceramic abrasive particles, with the proviso that if the fused, polycrystalline ceramic abrasive particles include eutectic microstructure, such fused, polycrystalline ceramic abrasive particles also include at least one complex Al₂O₃.metal oxide, and wherein the fused, polycrystalline ceramic abrasive particles comprise at least 35 (in some embodiments, at least 40, 45, 50, 55, 60, 65, 70, 75, 80, 85, 90, 95, 99, or even at least 99.9) percent by weight Al₂O₃, based on the total weight of the respective fused, polycrystalline ceramic abrasive particle. In some embodiments, at least a portion of cooling the melt comprises immersing the melt into a fluid (e.g., water). In some embodiments, at least a portion of the first plurality of particles are at least one of glass particles, crystalline particles, or glass-ceramic particles. In some embodiments, at least 50 (in some embodiments, at least 55, 60, 65, 70, 75, 80, 85, 90, 95, 99, or even 100) percent by volume of at least one of the first or second plurality of the plurality of particles that are melted to provide the melt or the fused, polycrystalline abrasive particles have particle sizes have particle sizes less than 1000 (in some embodiments, less than 750, 500, or even less than 250) micrometers. In some embodiments, the particles of the second plurality of particles are not greater than 100 (in some embodiments, 50, 25, 10, 5, 3, 2, or even not greater 1) micrometers. In some embodiments, the particles of the second plurality of the particles are greater than 1, 2, 3, 5, 10, 25, 50 or even 100 micrometers. In some embodiments, the flame forming is conducted at no more than 2500° C. (in some embodiments, in a range from 1900° C. to 2500° C., or even in a range from 2000° C. to 2500° C.). In some embodiments, the first plurality of particles has a first particle size distribution, and the second plurality of particles has a second particle size distribution, and wherein the first particle size distribution is substantially the same (i.e., the mean particle size of the first particle size distribution is from 75 to 125 (in some embodiments, from 80 to 120, 85 to 115 or even from 90 to 110 percent by number of the mean particle size of the second particle size distribution, respectively) as the second particle size distribution. The mean particle size for a particle size distribution are measured by commonly employed particle size analysis techniques including, sieving, sedimentation, centrifugal and microscopy techniques. The mean particle size refers to the statistical average particle size. In some embodiments, melting of the raw materials is conducted via flame forming or plasma spraying. In some embodiments, the particle size distribution of the first and second plurality of particles conforms to a specified nominal grade (e.g., at least one of an ANSI, FEPA, or JIS standard).

In one exemplary method according to the present invention for making a plurality of fused, polycrystalline ceramic abrasive particles, the method comprising:

melting raw materials to provide a melt (e.g., flame forming a melt), wherein the melt comprises at least 35 (in some embodiments, at least 40, 45, 50, 55, 60, 65, 70, 75, 80, 85, 90, 95, 99, or even at least 99.9) percent by weight Al₂O₃, based on the total weight of the melt, wherein the melt has a first composition;

cooling the melt to directly provide fused, polycrystalline material having a second composition, wherein the second composition is in a range from 75 to 125 (in some embodiments, in a range 80 to 120, 85 to 115, or even in a range 90 to 110) percent by weight of the first composition, and wherein the fused, polycrystalline material comprises at least 35 (in some embodiments, at least 40, 45, 50, 55, 60, 65, 70, 75, 80, 85, 90, 95, 99, or even at least 99.9) percent by weight Al₂O₃, based on the total weight of the fused, polycrystalline material; and

crushing the fused, polycrystalline material to provide fused, polycrystalline ceramic abrasive particles comprising at least 35 percent by weight Al₂O₃, based on the total weight of the respective fused, polycrystalline ceramic abrasive particle. In some embodiments, at least a portion of the raw materials to provide a melt are at least one of glass (e.g., particles), crystalline ceramic (e.g., particles), or glass-ceramic (e.g., particles). In some embodiments, wherein at least 50 (in some embodiments, at least 55, 60, 65, 70, 75, 80, 85, 90, 95, 99, or even 100) percent by volume of the raw materials have particle sizes less than 1000 (in some embodiments, less than 750, 500, or even less than 250) micrometers. In some embodiments, the flame forming is conducted at no more than 2500° C. (in some embodiments, in a range from 1900° C. to 2500° C., or even in a range from 2000° C. to 2500° C.). In some embodiments, the first plurality of particles has a first particle size distribution, and the second plurality of particles has a second particle size, distribution, and wherein the first particle size distribution is substantially the same (i.e., the mean particle size of the first particle size distribution is in a range from 75 to 125 (in some embodiments, in a range form 80 to 120, 85 to 115, or even in a range from 90 to 110 percent by number of the mean particle size of the second particle size distribution, respectively) as the second particle size distribution. The mean particle size for a particle size distribution are measured by commonly employed particle size analysis techniques including, sieving, sedimentation, centrifugal and microscopy techniques. The mean particle size refers to the statistical average particle size. In some embodiments, melting of the raw materials is conducted via flame forming or plasma spraying.

In this application:

“complex metal oxide” refers to a metal oxide comprising two or more different metal elements and oxygen (e.g., CeAl₁₁O₁₈, Dy₃Al₅O₁₂, MgAl₂O₄, and Y₃Al₅O₁₂);

“complex Al₂O₃.metal oxide” refers to a complex metal oxide comprising, on a theoretical oxide basis, Al₂O₃ and one or more metal elements other than Al (e.g., CeAl₁₁O₁₈, Dy₃Al₅O₁₂, MgAl₂O₄, and Y₃Al₅O₁₂);

“complex Al₂O₃.Y₂O₃” refers to a complex metal oxide comprising, on a theoretical oxide basis, Al₂O₃ and Y₂O₃ (e.g., Y₃Al₅O₁₂);

“complex Al₂O₃.REO” refers to a complex metal oxide comprising, on a theoretical oxide basis, Al₂O₃ and rare earth oxide (e.g., CeAl₁₁O₁₈ and Dy₃Al₅O₁₂);

“fused” refers to crystalline material cooled directly from a melt or crystalline material made by heat-treating crystalline material cooled directly from a melt (e.g., alpha alumina made by heat-treating transitional alumina cooled directly from a melt);

“rare earth oxides” refers to cerium oxide (e.g., CeO₂), dysprosium oxide (e.g., Dy₂O₃), erbium oxide (e.g., Er₂O₃), europium oxide (e.g., Eu₂O₃), gadolinium oxide (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium oxide (e.g., Tb₂O₃), thorium oxide (e.g., Th₄O₇), thulium oxide (e.g., Tm₂O₃), and ytterbium oxide (e.g., Yb₂O₃), and combinations thereof; and

“REQ” refers to rare earth oxide(s).

Fused, polycrystalline ceramic abrasive particles made according to the present invention can be incorporated into an abrasive article, or used in loose form Abrasive particles are usually graded to a given particle size distribution before use. Such distributions typically have a range of particle sizes, from coarse particles to fine particles. In the abrasive art this range is sometimes referred to as a “coarse”, “control”, and “fine” fractions. Abrasive particles graded according to abrasive industry accepted grading standards specify the particle size distribution for each nominal grade within numerical limits. Such industry accepted grading standards (i.e., specified nominal grades) include those known as the American National Standards Institute, Inc. (ANSI) standards, Federation of European Producers of Abrasive Products (FEPA) standards, and Japanese Industrial Standard (JIS) standards.

In one aspect, the present invention provides a plurality of abrasive particles having a specified nominal grade, wherein at least a portion of the plurality of abrasive particles are fused, polycrystalline ceramic abrasive particles made according to the present invention. In some embodiments, at least 5, 10, 15, 20, 25, 30, 35, 40, 45, 50, 55, 60, 65, 70, 75, 80, 85, 90, 95, or even 100 percent by weight of the plurality of abrasive particles are fused, polycrystalline ceramic abrasive particles made according to the present invention, based on the total weight of the plurality of abrasive particles.

For some embodiments of methods according to the present invention, the method further comprises grading fused, polycrystalline ceramic abrasive particles made according to the present invention to provide a plurality of particles having a specified nominal grade. In some embodiments, the fused polycrystalline ceramic abrasive particles are crushed or otherwise reduced in size prior to grading.

In another aspect, the present invention provides an abrasive article comprising a binder and a plurality of abrasive particles, wherein at least a portion of the abrasive particles are fused, polycrystalline ceramic abrasive particles made according to the present invention.

Exemplary abrasive products include coated abrasive articles, bonded abrasive articles (e.g., wheels), non-woven abrasive articles, and abrasive brushes. Coated abrasive articles typically comprise a backing having first and second, opposed major surfaces, and wherein the binder and the plurality of abrasive particles form an abrasive layer on at least a portion of the first major surface.

In some embodiments, at least 5, 10, 15, 20, 25, 30, 35, 40, 45, 50, 55, 60, 65, 70, 75, 80, 85, 90, 95, or even 100 percent by weight of the abrasive particles in an abrasive article are fused, polycrystalline ceramic abrasive particles made according to the present invention, based on the total weight of the abrasive particles in the abrasive article.

The present invention also provides a method of abrading a surface, the method comprising:

contacting fused, polycrystalline ceramic abrasive particles made according to the present invention with a surface of a workpiece; and

moving at least one of the fused, polycrystalline ceramic abrasive particles made according to the present invention or the contacted surface to abrade at least a portion of the surface with at least one of the fused, polycrystalline ceramic abrasive particles made according to the present invention.

### BRIEF DESCRIPTION OF THE DRAWING

FIG. 1 is a side view of an exemplary embodiment of an apparatus including a powder feeder assembly for a flame-melting apparatus.

FIG. 2 is a section view of the apparatus of FIG. 1.

FIG. 3 is an exploded section view of the apparatus of FIG. 1.

FIG. 4 is a side view of a portion of the powder feeder assembly of FIG. 1.

FIG. 5 is a perspective view of a portion of the powder feeder assembly of FIG. 1.

FIG. 6 is a cross-sectional view of a portion of the powder feeder assembly of FIG. 1.

FIG. 7 is a fragmentary cross-sectional schematic view of a coated abrasive article including fused, polycrystalline ceramic abrasive particles made according to the present invention.

FIG. 8 is a perspective view of a bonded abrasive article including fused, polycrystalline ceramic abrasive particles made according to the present invention.

FIG. 9 is an enlarged schematic view of a portion of a non-woven, abrasive article including fused, polycrystalline ceramic abrasive particles made according to the present invention.

FIG. 10 is an electronphotomicrograph of fused polycrystalline material made according to Example 1.

FIG. 11 is an electronphotomicrograph of fused polycrystalline material made according to Example 4.

FIG. 12 is an electronphotomicrograph of fused polycrystalline material made according to Example 7.

FIG. 13 is an electronphotomicrograph of fused polycrystalline material made according to Example 9.

FIG. 14 is an electronphotomicrograph of fused polycrystalline material made according to Example 10.

FIG. 15 is an electronphotomicrograph of fused polycrystalline material made according to Example 11.

### DETAILED DESCRIPTION

The present invention provides methods for making fused, polycrystalline ceramic abrasive particles from melts. Raw materials for forming fused, polycrystalline ceramic material and the melts include the following.

Sources, including commercial sources, of (on a theoretical oxide basis) Al₂O₃ include bauxite (including both natural occurring bauxite and synthetically produced bauxite), calcined bauxite, hydrated aluminas (e.g., boehmite, and gibbsite), aluminum, Bayer process alumina, aluminum ore, gamma alumina, alpha alumina, aluminum salts, aluminum nitrates, and combinations thereof. The Al₂O₃ source may provide only Al₂O₃. Alternatively, the Al₂O₃ source may provide Al₂O₃, as well as one or more metal oxides other than Al₂O₃ (including materials of or containing complex Al₂O₃.metal oxides (e.g., Dy₃Al₅O₁₂, Y₃Al₅O₁₂, CeA₁₁O₁₈, etc.)). The Al₂O₃ source may also include, for example, minor amounts of silica, iron oxide, titania, and carbon.

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). Alternatively, the rare earth oxide(s) source may contain, or provide rare earth oxide(s), as well as one or more metal oxides other than rare earth oxide(s) (including materials of or containing complex rare earth oxide.other metal oxides (e.g., Dy₃Al₅O₁₂, CeAl₁₁O₁₈, etc.)).

Sources, including commercial sources, of (on a theoretical oxide basis) Y₂O₃ include yttrium oxide powders, yttrium, yttrium-containing ores, and yttrium salts (e.g., yttrium carbonates, nitrates, chlorides, hydroxides, and combinations thereof). The Y₂O₃ source may contain, or only provide, Y₂O₃. Alternatively, the Y₂O₃ source may contain, or provide Y₂O₃, as well as one or more metal oxides other than Y₂O₃ (including materials of or containing complex Y₂O₃.metal oxides (e.g., Y₃Al₅O₁₂)).

Other useful metal oxides may also include, on a theoretical oxide basis, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof. Sources, including commercial sources, include the oxides themselves, metal powders, complex oxides, ores, carbonates, acetates, nitrates, chlorides, hydroxides, etc.

Sources, including commercial sources, of (on a theoretical oxide basis) ZrO₂ include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the ZrO₂ source may contain, or provide ZrO₂, as well as other metal oxides such as hafnia. Sources, including commercial sources, of (on a theoretical oxide basis) HfO₂ include hafnium oxide powders, hafnium, hafnium-containing ores, and hafnium salts. In addition, or alternatively, the HfO₂ source may contain, or provide HfO₂, as well as other metal oxides such as ZrO₂. In some embodiments, the zirconia may be stabilized zirconia. Typical stabilizers for zirconia include yttria, calcia, magnesia, ceria, or other rare earth oxides.

For embodiments comprising ZrO₂ and HfO₂, the weight ratio of ZrO₂:HfO₂ may be in a range of 1:zero (i.e., all ZrO₂; no HfO₂) to zero:1, as well as, for example, at least about 99, 98, 97, 96, 95, 90, 85, 80, 75, 70, 65, 60, 55, 50, 45, 40, 35, 30, 25, 20, 15, 10, and 5 parts (by weight) ZrO₂ and a corresponding amount of HfO₂ (e.g., at least about 99 parts (by weight) ZrO₂ and not greater than about 1 part HfO₂) and at least about 99, 98, 97, 96, 95, 90, 85, 80, 75, 70, 65, 60, 55, 50, 45, 40, 35, 30, 25, 20, 15, 10, and 5 parts HfO₂ and a corresponding amount of ZrO₂.

In some embodiments, it may be advantageous for at least a portion of a metal oxide source (in some embodiments, 10, 15, 20, 25, 30, 35, 40, 45, 50, 55, 60, 65, 70, 75, 80, 85, 90, 95, or even 100 percent by weight) to be obtained by adding particulate metallic material comprising at least one of a metal (e.g., Al, Ca, Cu, Cr, Fe, Li, Mg, Ni, Ag, Ti, Zr, and combinations thereof), M, that has a negative enthalpy of oxide formation or an alloy thereof, or otherwise combining them with the other raw materials. Although not wanting to be bound by theory, it is believed that the heat resulting from the exothermic reaction associated with the oxidation of the metal is beneficial in the formation of a homogeneous melt and resulting fused, polycrystalline ceramic material. For example, it is believed that the additional heat generated by the oxidation reaction within the raw material (typically feed particles) eliminates, minimizes, or at least reduces insufficient heat transfer, and hence facilitates formation and homogeneity of the resulting melt. It is also believed that the availability of the additional heat aids in driving various chemical reactions and physical processes (e.g., densification, and spherodization) to completion. Further, it is believed for some embodiments, the presence of the additional heat generated by the oxidation reaction actually enables the formation of a melt, which otherwise is difficult or not practical due to high melting point of the materials. Another advantage including particulate metallic material in forming the fused, polycrystalline ceramic material is that many of the chemical and physical processes such as melting, densifying, and spherodizing can be achieved in a short time.

Particulate raw materials are typically selected to have particle sizes such that the formation of homogeneous feed particles, and in turn melt, can be achieved rapidly. Typically, raw materials with relatively small average particle sizes are used for this purpose. For example, those having an average particle size in a range from about 5 nm to about 50 micrometers (in some embodiments, in a range from about 10 nm to about 20 micrometers, or even about 15 nm to about 1 micrometer), wherein at least 90 (in some embodiments, 95, or even 100) percent by weight of the particulate is the raw material, although sizes outside of these sizes may also be useful. Particulate raw materials less than about 5 nm in size tends to be difficult to handle (e.g., the flow properties of the raw materials particles tended to be undesirable as they tend to have poor flow properties). Use of particulate raw material larger in size than about 50 micrometers in typical flame forming or plasma spraying processes tend to make it more difficult to obtain homogenous melts and fused, polycrystalline ceramic material and/or the desired composition. In some embodiments, flame forming is conducted at no more than 2500° C. (in some embodiments, in a range from 1900° C. to 2500° C., or even in a range from 2000° C. to 2500° C.).

Further, in some cases, for example, when feed particles are fed in to a flame or thermal or plasma spray apparatus, to form the melt, it may be desirable for the particulate raw materials to be provided in a range of particle sizes. Although not wanting to be bound by theory, it is believed that this facilitates the packing density and strength of the feed particles. Further, raw material particles that are too coarse, tend to produce thermal and mechanical stresses in the feed particles, for example, during flame forming or plasma spraying step. The end result in such cases is generally, fracturing of the feed particles in to smaller fragments, loss of compositional uniformity, loss of yield, or even incomplete melting as the fragments generally change their trajectories in a multitude of directions out of the heat source.

In one aspect, the feed particles (which may include, or be, for example, previously-fused polycrystalline material) are fed independently into a flame to form the molten mixture. In another aspect, the feed particles may comprise previously fused material mixed together with other particulate raw materials. It is also within the scope of the present invention to feed previously fused material into a flame, while other raw materials are added independently into the flame to form the molten mixture. In the latter case, the mixing of the components is believed to occur by coalescing of the molten droplets in the flame.

In some embodiments, for example, the raw materials are combined or mixed together prior to melting to form the feed materials. The raw materials may be combined in any suitable and known manner to form a substantially homogeneous mixture. These combining techniques include ball milling, mixing, tumbling, and the like. The milling media in the ball mill may be, for example, metal balls, ceramic balls, and the like. The ceramic milling media may be, for example, alumina, zirconia, silica, magnesia, and the like. The ball milling may occur dry, in an aqueous environment, or in a solvent-based (e.g., isopropyl alcohol) environment. If the raw material batch contains metal powders, then it is generally desired to use a solvent during milling. This solvent may be any suitable material with the appropriate flash point and ability to disperse the raw materials. The milling time may be from a few minutes to a few days, generally between a few hours to 24 hours. In a wet or solvent based milling system, the liquid medium is removed, typically by drying and/or filtering, so that the resulting mixture is typically homogeneous and substantially devoid of the water and/or solvent. If a solvent based milling system is used, during drying, a solvent recovery system may be employed to recycle the solvent. After drying, the resulting mixture may be in the form of a “dried cake”. This cake-like mixture may then be broken up or crushed, for example, into the desired particle size prior to melting. Alternatively, for example, spray-drying techniques may be used. The latter typically provides spherical particulates of a desired oxide mixture. The feed material may also be prepared by wet chemical methods including precipitation and sol-gel. Such methods will be beneficial if extremely high levels of purity and homogeneity are desired.

It is within the scope of the present invention for the feed particles to be sintered material. Use of sintered material may be advantageous, for example, as any volatiles were removed during the sintering process, and conversion of precursor raw materials to corresponding oxides also occurred during the sintering process.

The size of feed particles can typically be up to 1000 micrometers (in some embodiments up to 500, 250, 100, or even up to 50 micrometers), and may have a narrow or wide particle size distribution. Generally, the feed particle size characteristics used are determined by the desired size (distribution) of the resulting fused, polycrystalline material. Although not wishing to be bound by theory, it is believed it is possible, for example, for the resulting fused, polycrystalline material to have a larger average particle size than the corresponding average feed particle size, due to coalescing of some molten particles in the flame. Further, it is also believed, for example, it is also possible for the fused, polycrystalline material to have a substantially smaller average particle size than the corresponding feed particles, due to densification and fracturing of the feed particles in the flame. In general, it is desirable for the size of the feed particles to be larger than the largest particulate raw material powders, to facilitate mixing of the various components at the desired ratios. Also, there is generally an upper particle size limit for the feed particles for any composition. This upper particle size limit depends on a number of parameters, such as the thermal conductivity, heat capacity, etc., of the various components as well as the overall composition. Furthermore, the porosity of the feed particles, the type and the heat content of the flame, the residence time of the feed particles in the flame, and the occurrence and the type of chemical reactions among the components influence the largest allowable feed particle size.

It is within the scope of the present invention to provide one or more of the components of the feed material (i.e., the starting materials) in a form other than a particulate, including for example as precursor salts (e.g., as nitrates, acetates etc.), polymeric (e.g., silanes) or organometallic (e.g., alkoxides) form. The precursor salts, polymers, or the organometallics may be dissolved or dispersed in a suitable solvent (e.g., water, acetone, ethers, alcohols, and hydrocarbons (e.g., cyclohexane) prior to feeding in to the flame. Additionally, the feed particles may be dispersed, for example, in a solvent (e.g., water, acetone, ethers, alcohols, and hydrocarbons (e.g., cyclohexane)) prior to feeding into the flame. If the feed particles are dispersed in a solvent, it is desirable to control the size of the dispersion droplets in the flame. If the feed dispersion droplets are too big, volatilization of the solvent tends to be incomplete, and conversion of the feed particles in to melt droplets may not occur.

It is generally desirable for the feed particles to be fed into the flame, for example by techniques such as using screw feeders, vibratory feeders, and the like, without agglomeration, or so-called “clumping”. Undesirable agglomeration and/or clumping of the feed particles may cause incomplete or non-uniform melting of the particles, or highly porous final products. In some cases the feed particles may be mixed with colloidal (such as fumed silica and alumina) or lubricant (such as stearic acid) powders to keep feed particles monodispersed, and aid in uniform feeding in to the flame.

Fused polycrystalline ceramic material according to the present invention can be made by heating the appropriate metal oxide sources in a flame or plasma to form a melt, desirably a homogenous melt, and then rapidly cooling the melt to provide fused, polycrystalline ceramic material. It is typically desirable to heat the melt 20° C. to 200° C. higher than the melting temperature to lower the viscosity of the melt and facilitate more complete mixing of the components.

The fused, polycrystalline ceramic material is typically obtained by relatively rapidly cooling the molten material (i.e., the melt). The quench rate (i.e., cooling rate) to obtain the fused, polycrystalline ceramic material depends upon many factors, including the chemical composition of the fused, polycrystalline ceramic material, the thermal properties of the melt and the resulting fused, polycrystalline ceramic material, the processing technique(s), the dimensions and mass of the resulting fused, polycrystalline ceramic material, and the cooling technique.

The cooling rate is believed to affect the properties of the fused polycrystalline material. For instance, the density, average crystallite size, shape of crystals, and/or other properties of fused polycrystalline material typically change with cooling rates. Typically, the faster the cooling rate, the smaller the resulting crystal size, although if the cooling rate is too fast, the resulting material may be amorphous. Although not wanting to be bound by theory, the cooling rates achieved in making the fused, polycrystalline ceramic material are believed typically to be higher than 10²° C./sec (i.e., a temperature drop of 100° C. from a molten state in less than 1 second); typically higher than 10³° C./sec (i.e., a temperature drop of 1000° C. from a molten state in less than 1 second). Techniques for cooling the melt include discharging the melt into a cooling media (e.g., high velocity air jets, liquids (e.g., cold water), metal plates (including chilled metal plates), metal rolls (including chilled metal rolls), metal balls (including chilled metal balls), and the like). Other cooling techniques known in the art include roll-chilling. Roll-chilling can be carried out, for example, by melting the metal oxide sources at a temperature typically 20-200° C. higher than the melting point, and cooling the melt by spraying it under high pressure (e.g., using a gas such as air, argon, nitrogen or the like) onto a high-speed rotary roll(s). Typically, the rolls are made of metal and are water-cooled. Metal book molds may also be useful for cooling the melt. In some embodiments, the book molds and/or rollers, etc., are immersed in water.

Additional details for making fused polycrystalline ceramic abrasive particles can be found, for example, in copending applications having U.S. Ser. No. ______ (Attorney Docket Nos. 58794US002, 58796US002, 59437US002, and 59439US002), filed on the same date as the instant application, the disclosures of which are incorporated herein by reference.

Rapid cooling may also be conducted under controlled atmospheres, such as a reducing, neutral, or oxidizing environment to maintain and/or influence the desired oxidation states, the phase composition, etc. during cooling. The atmosphere can also influence crystal formation by influencing crystallization kinetics or mechanism from undercooled liquid. For example, larger undercooling of Al₂O₃ melts without crystallization has been reported in argon atmosphere as compared to that in air.

In one method, feed materials (which may include or be, for example, fused, polycrystalline ceramic material to be re-melted and/or ceramic particles comprising glass) having the desired composition can be converted into a melt, for example, using a flame forming process, and then cooling the melt to form fused, polycrystalline ceramic material. An exemplary flame fusion process is reported, for example, in U.S. Pat. No. 6,254,981 (Castle). In this method, the metal oxide sources are fed (e.g., in the form of particles, sometimes referred to as “feed particles”) directly into a burner (e.g., a methane-air burner, an acetylene-oxygen burner, a hydrogen-oxygen burner, and the like).

Other techniques for making fused, polycrystalline ceramic material include, single roller and twin roller quenching, and roller-plate quenching (see, e.g., Rapid Solidification of Ceramics, Brockway et al., Metals And Ceramics Information Center, A Department of Defense Information Analysis Center, Columbus, Ohio, January, 1984). Further, other techniques for making melts and fused, polycrystalline ceramic material include plasma

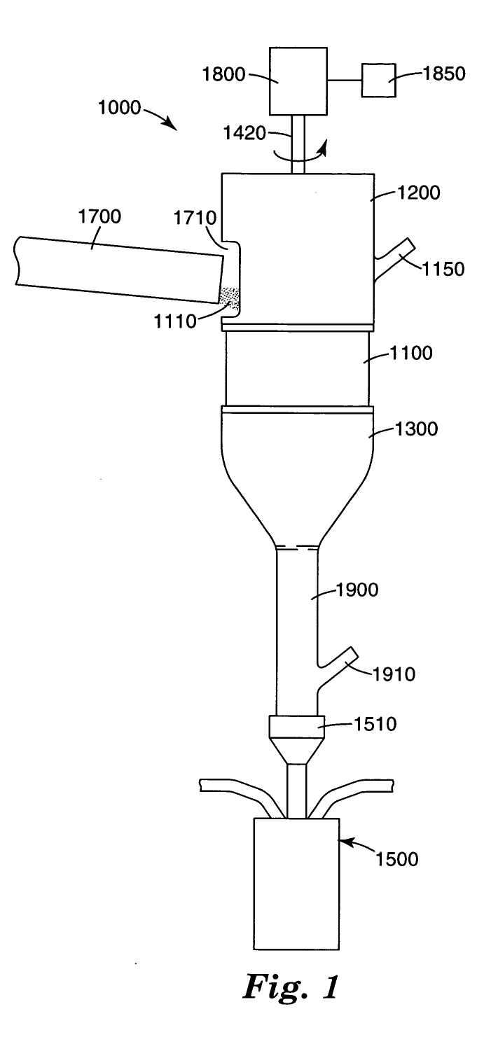

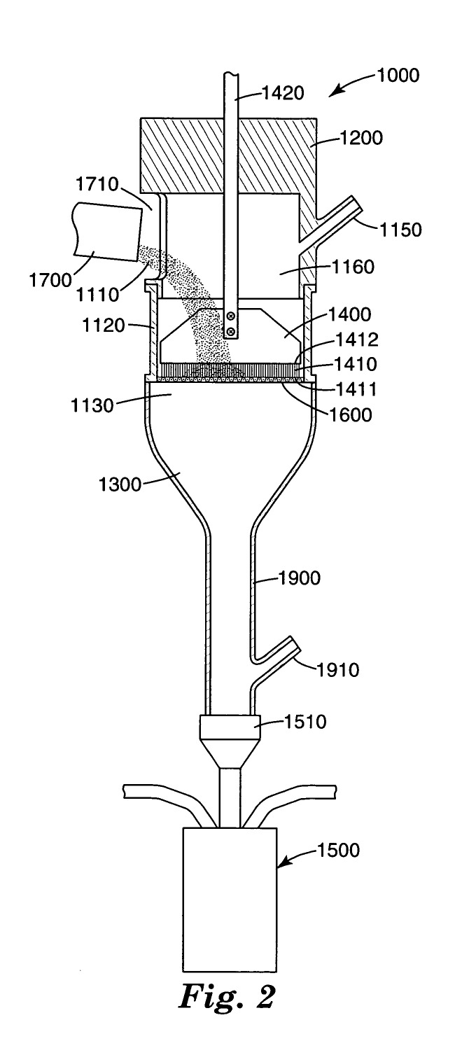

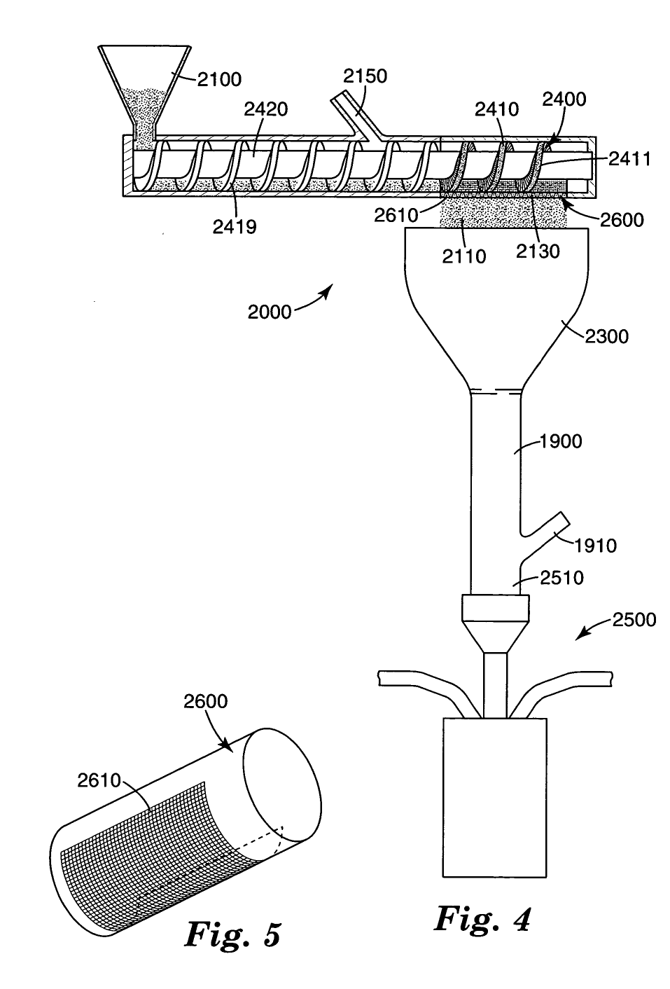

Another exemplary powder feeder apparatus is illustrated in FIGS. 1-6. The powder feeder assembly 1000 holds and delivers powder 1110 to a flame-melting device 1500. The flame-melting device 1500 includes a powder receiving section 1510 for receiving powder 1110 for melting and transforming into another material(s), such as those disclosed herein. Powder 1110 is delivered into the powder receiving section 1510 through a discharge opening 1130 of the powder feeder assembly 1000. A connecting tube 1900 is positioned between the discharge opening 1130 and the powder receiving section 1510. Also, a funnel 1300 is positioned proximate to the discharge 1130 opening for receiving and directing powder 1110 flow after it leaves the discharge opening 1130.

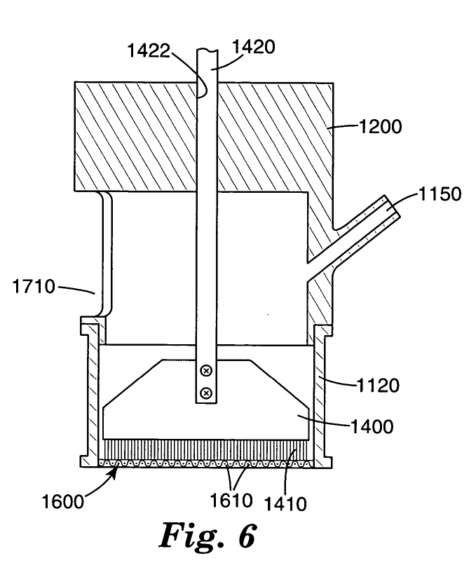

The powder feeder assembly 1000 includes a hopper 1100 for holding powder 1110. Typically, the hopper 1100 includes a body 1120 defined by a cylindrical wall, though other body shapes are possible. Also, the hopper 1100 can be made from a unitary piece or multiple pieces. The hopper 1100 in the example embodiment illustrated also includes a cover section 1200. The cover section 1200 includes an opening 1710 for feeding powder 1110 into the hopper 1100. Any commercially available delivery means can be used for filling the hopper 1100 with powder 1110, such as a screw feeder, vibratory feeder, or brush feeder. The cover section 1200 can also include a section 1415 having a shaft receiving opening 1422 (as illustrated in FIG. 6).

A brush assembly 1400 is disposed within the hopper 1100 body 1120. The brush assembly 1400 is connected to means for rotating the brush assembly 1400, such as a motor 1800. The motor 1800 can also be connected to means for adjusting the speed of the motor 1800, such as a motor speed controller 1850. The brush assembly used was a Nylon Strip Brush (1 inch (2.5 cm) overall height, 5/16 inch (0.8 cm) bristle length and 0.020 inch (5 millimeter) diameter), part# 74715T61, available from McMaster-Carr, Chicago, Ill. The brush assembly was coupled to a shaft, which in turn was coupled to and driven by a DC Gear Motor (130 Volt, Ratio 60:1, Torque 22 Lb-in), available from Bodine Electric Company, Chicago, Ill. The speed of the motor was controlled using a Type-FPM Adjustable Speed PM Motor Control, Model # 818, also available from Bodine.

The brush assembly 1400 includes a bristle element 1410 having a distal 1411 and a proximate end 1412. When powder 1110 is placed into the hopper 1100 for delivery to the flame-melting device 1500, the brush assembly 1400 is rotated within the hopper 1100. When the brush assembly 1400 is rotated, the, the bristle element(s) 1410 urges powder 1110 in the hopper 1100 through a screening member 1600. By adjusting the rotational speed of the brush assembly 1400, the feed rate of the powder 1110 through the screening member 1600 can be controlled.

The brush assembly 1400 cooperates with the screening member 1600 to deliver powder 1110 having desired properties from the discharge opening 1130 to the powder receiving section 1510 of the flame-melting device 1500. Distal end 1411 of bristle 1410 is located in close proximity to the screening member 1600. While a small gap between distal end 1411 of bristles 1410 and screening member 1600 can be used, it is typical to keep the gap on the same order of magnitude as the particle size of the powder, however, one of ordinary skill in the art will appreciate that the gap can be much larger, depending on the particular properties of the powder being handled. Also, distal end 1411 of bristle 1410 can be positioned flush with screening member 1600 or positioned to protrude into and extend through the mesh openings 1610 in the screening member 1600. For the bristles 1410 to protrude through the openings 1610, at least some of the bristles 1410 need to have a diameter smaller than the mesh size. Bristle elements 1410 can include a combination of bristles with different diameters and lengths, and any particular combination will depend on the operating conditions desired.

Extending the bristle 1400 end 1411 into and through the openings 1610 allows the bristles 1410 to break up any particles forming bridges across openings 1610. Also the bristles 1410 will tend to break-up other types of blockages that can occur typical to powder feeding. The bristle element 1410 can be a unitary piece, or can also be formed from a plurality of bristle segments. Also, if it is desired that the bristle elements extend into and/or through the mesh openings, then the bristle 1410 size selected needs to be smaller than the smallest mesh opening 1610.

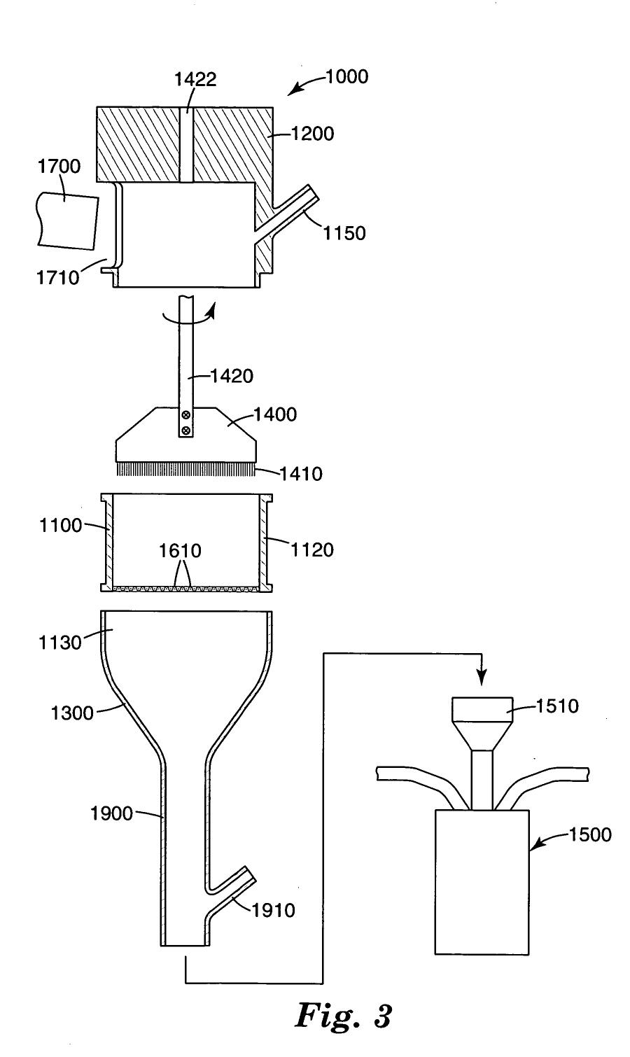

Referring to FIG. 3, in the exemplary embodiment illustrated, the hopper 1100 can include a wall defining a cylindrical body 1120. This shape conveniently provides for symmetry that allows for a more controlled flow rate of powder from the discharge opening 1130. Also, the cylindrical shape is well suited for using with a rotating brush assembly 1400, since the bristle element 1410 can extend to the wall, leaving little or no area on the screening member that can accumulate powder. However, other geometries are possible, as the particular conditions of use dictate.

The hopper 1100 also includes a cover section 1200. The cover section 1200 has an opening 1710 for receiving powder 1110 from a hopper feeder assembly 1700. The cover section 1200 cooperates with the body 1120 to form a powder chamber 1160. The opening 1710 on the cover 1200 can also be omitted or sealable so that a gas, such as nitrogen, argon, or helium can be input into a gas input line 1150 on the hopper 1100 for neutralizing the atmosphere or assisting in delivering the powder or particles to the flame-melting device. Also, gas can be used in the system for controlling the atmosphere surrounding the powder or particles. Also, a gas input line 1910 can be placed after the discharge opening 1130, for example, on the connecting tube 1900.

The entire powder feeder assembly 1000 can be vibrated to further assist in powder transport. Optionally, the screening member can be vibrated to assist powder transport through the powder feeder assembly 1000. One of ordinary skill in the art will recognize that other possible vibrating means can be used, and there are abundant commercial vibrating systems and devices that are available depending on the particular conditions of use.

Referring to FIG. 6, when hopper 1100 includes a cover 1200 and a body 1120, the removable cover 1200 allows easy access to powder chamber 1160 for cleaning or changing the screening member 1600. Also, the brush assembly 1400 can be positioned to form the desired engagement between the bristle elements 1410 and the screening member 1600. When the brush assembly 1400 is attached to a rotating shaft 1420, the shaft 1420 can protrude outside opening 1422 in the cover 1200 to be driven, for example, by a motor 1800. The speed of the brush assembly 1400 can be controlled by means such as a speed controller 1850. Further details regarding this exemplary powder feeding apparatus can be found in co-pending application having U.S. Ser. No. ______ (Attorney Docket No. 59440US002), filed the same date as the instant application, the disclosure of which is incorporated herein by reference.

Embodiments of methods according to the present invention are typically simpler, more flexible, and require less capital than conventional fusion processes. In addition, embodiments of methods according to the present invention allow more control over the particle composition and size, and offer the ability to make particles of a required size distribution (e.g., as made are in a specified nominal grade).

The rollers, surfaces, etc. can be made of a variety of materials including metals (e.g., steels (including stainless steel and alloy steels), copper, brass, aluminum and aluminum alloys, and nickel) or graphite. Generally, suitable materials have high thermal conductivity and good thermal stability against rapid temperature changes and good stability against mechanical shocks. In some embodiments, the various surfaces may employ a liner to facilitate, for example, more cost efficient maintenance and/or initial design and acquisition of the surfaces. For example, the core of the surfaces may be of one material while the liners may be another with the desired thermal, chemical, and mechanical properties. The liners maybe more or less expensive, easier to machine than the core, etc. Further, liners may be replaced after one or more uses. To improve the heat removing ability of the rollers, surfaces, etc. they may be cooled, for example, by circulating liquid (e.g., water) and/or by blowing a cooling gas (e.g., air, nitrogen, and argon) on them, as well as immersing the rollers in a cooling medium (e.g., water).

The rollers and surfaces can be in a variety of sizes, depending, for example, on the size of the operation, the desired quantity of particles, the amount of melt to be processed, and/or the flow rate of the melt. The speed at which the rollers, and/or surfaces move may depend, for example, on the desired cooling rates, the material output of the process, etc.

Although not wanting to be bound by theory, it is believed that the relative fractions of phases (e.g., alpha-alumina to transitional-alumina phases) typically present in some embodiments of fused polycrystalline material according to the present invention is affected at least in part by the cooling rate. For example, while not wanting to be bound by theory, it is believed that the faster cooling rates typically favor the formation of gamma or other transitional alumina phases, while lower cooling rates favor formation of alpha alumina. The desired amount of alpha-alumina and transitional alumina in fused polycrystalline abrasive materials according to the present invention depends, for example, on the intended use. For abrasive applications requiring high rates of material removal, higher percentages of alpha alumina are typically desired. On the other hand if low rates of material removal are desired, such as during polishing, higher percentages of transitional alumina may be desired. In some embodiments, at least a portion of transitional (e.g., gamma) Al₂O₃, if present, in the fused polycrystalline material made according to the present invention can be heat-treated to convert at least a portion of the transitional (e.g., gamma) Al₂O₃ to alpha Al₂O₃.

In some embodiments, the present invention provides fused polycrystalline material comprising (a) alpha alumina having an average crystallite size in a range from 1 to 10 micrometers, and (b) complex Y₂O₃.metal oxide present as a distinct crystalline phase. In some embodiments, the present invention provides fused polycrystalline material comprising Al₂O₃ and Y₂O₃, wherein at least a portion of the Al₂O₃ is transitional (e.g., gamma) Al₂O₃, and wherein at least a portion of the Al₂O₃ and Y₂O₃ are present as a complex Al₂O₃.Y₂O₃.

In some embodiments, the fused polycrystalline material comprising (a) alpha alumina having an average crystallite size in a range from 1 to 10 micrometers, and (b) complex Y₂O₃.metal oxide present as a distinct crystalline phase can be provided by heating (typically above 900° C., although lower temperatures may also be useful) the fused polycrystalline material comprising Al₂O₃ and Y₂O₃, wherein at least a portion of the Al₂O₃ is transitional (e.g., gamma) Al₂O₃, and wherein at least a portion of the Al₂O₃ and Y₂O₃ are present as a complex Al₂O₃.Y₂O₃ such that at least a portion of the transitional (e.g., gamma) Al₂O₃ is converted to alpha Al₂O₃ (in some embodiments, at least 50, 60, 75, 90, 96, 99, or even 100 percent by volume, based on the total volume of the amount of transitional (e.g., gamma) alumina prior to heating). Typically it is desirable to heat at temperatures not great than 1600° C. Higher temperatures may lead to a rapid undesirable deterioration of the fused polycrystalline material due to grain growth. Generally, the higher the heating temperature the shorter the heating time needs to be to affect conversion of the transitional (e.g., gamma) alumina to alpha alumina. For lower temperatures, longer heating times may be desirable. Most typically heating is conducted in a range from 1000° C. to 1300° C., for a period in a range from 5 minutes to 3 hours (in some embodiments, in a range from 10 minutes to 1 hour). Any of a variety of furnaces known in the art may be useful for the heating, including box and rotary furnaces. In another aspect, the furnaces may be, for example, resistively or inductively heated.

If size reduction and/or change in particle shape is desired, such reduction and/or change in particle shape can be obtained, for example, using crushing and/or comminuting techniques known in the art. Such particles can be converted into smaller pieces and/or different shapes, or for example, using crushing and/or comminuting techniques known in the art, including roll crushing, jaw crushing, hammer milling, ball milling, jet milling, impact crushing, and the like. In order to produce the desired particle size distribution (sometimes referred to as grit size or grade), it may be necessary to perform multiple crushing steps. In general the crushing conditions are optimized to achieve the desired particle shape(s) and particle size distribution. Resulting particles that are not of the desired size may be re-crushed if they are too large. In another aspect, if resulting particles are not of the desired size they may be used as a raw material for re-melting.

The shape of the fused, polycrystalline, eutectic alumina-based abrasive particles according to the present invention can depend, for example, on the composition and/or microstructure of the ceramic, the geometry in which it was cooled, and the manner in which the ceramic is crushed (i.e., the crushing technique used). In general, where a “blocky” shape is preferred, more energy may be employed to achieve this shape. Conversely, where a “sharp” shape is preferred, less energy may be employed to achieve this shape. The crushing technique may also be changed to achieve different desired shapes. For some particles an average aspect ratio ranging from 1:1 to 5:1 is typically desired, and in some embodiments 1.25:1 to 3:1, or even 1.5:1 to 2.5:1.

The addition of certain metal oxides may alter the properties and/or crystalline structure or microstructure of fused, polycrystalline ceramic materials according to the present invention.

The particular selection of metal oxide sources and other additives for making fused, polycrystalline ceramic abrasive particles according to the present invention typically takes into account, for example, the desired composition, the microstructure, the degree of crystallinity, the physical properties (e.g., hardness or toughness), the presence of undesirable impurities, and the desired or required characteristics of the particular process (including equipment and any purification of the raw materials before and/or during fusion and/or solidification) being used to prepare the ceramics.

In some instances, it may be desirable to incorporate limited amounts of metal oxides selected from the group consisting of: BaO, CaO, Cr₂O₃, CoO, CuO, Fe₂O₃, GeO₂, HfO₂, Li₂O, MgO, MnO, NiO, Na₂O, Sc₂O₃, SrO, TiO₂, Y₂O₃, rare earth oxides, ZnO, ZrO₂, and combinations thereof. Sources, including commercial sources, include the oxides themselves, complex oxides, elemental powders, ores, carbonates, acetates, nitrates, chlorides, hydroxides, etc. If the modifying metal oxides are added in a form that is volatile, it is desirable to convert the volatile species the corresponding oxides or remove the volatiles by a suitable heat treatment such as calcination or sintering, prior to flame forming. If the volatile species are not removed prior to the flame forming, the residual volatile species typically tend to cause formation of substantial porosity (i.e., bubbles) in the resulting ceramic. Alternatively, the resulting porous fused, polycrystalline ceramic material according to the present invention may be fed through the flame multiple times to allow escape of the gases and increase the density of fused, polycrystalline ceramic material according to the present invention.

The metal oxides when used are typically added from greater than 0 to 49 (in some embodiments, greater than 0 to 40, greater than 0 to 30, greater than 0 to 25, greater than 0 to 20, greater than 0 to 15, greater than 0 to 10, greater than 0 to 5, or even greater than 0 to 2) percent by weight collectively of the fused, polycrystalline ceramic material.

Some metal oxides (e.g., yttria, calcia, magnesia, ceria, and rare earth oxides) known to stabilize the tetragonal (cubic) forms of the zirconia may be added into the composition by the use of stabilized zirconia powders, or may be added independently as part of the feed materials. The stabilizing oxides tend to increase the percent tetragonal (cubic) zirconia content of the resulting fused, polycrystalline ceramic abrasive particles according to the present invention. In some embodiments, the oxide additives (e.g., yttria, calcia, magnesia, ceria, and rare earth oxides) may contribute to the formation of ternary or even higher order eutectics. The microstructural features of ternary or higher order eutectics are typically similar to those of binaries, although the physical properties may be significantly different.

Fused polycrystalline abrasive particles made according to the present invention may contain a minor (typically less than about 10 (or even less than 5, 4, 3, 2, or even less than 1 (and in some embodiments zero)) percent by weight) amount of amorphous/glass material.

Some metal oxide additives or their reaction products with alumina, zirconia, or other metal oxide additives may precipitate from the melt and form distinct crystals within a matrix of fused, polycrystalline ceramic materials. The oxide precipitates may have a variety of shapes (equiaxed, faceted or non-faceted prismatic or dendritic shapes) and sizes. In some embodiments, the oxide crystals are smaller than 10 micrometers, 5 micrometers, 3 micrometers, 2 micrometers, or even less than 1 micrometer. The metal oxide crystals may impart desirable properties to fused, polycrystalline ceramic abrasive particles according to the present invention, such as increased hardness, or desirably affect the microstructure (e.g., refine the size of eutectic cells). For alumina-zirconia, for example, if the oxide additive(s) has a significantly lower density than the alumina-zirconia (i.e., if the metal oxide additive is present at a very high volume percent), then the fused, polycrystalline ceramic abrasive particle according to the present invention may be present as an interconnected film separating crystals of the metal oxide additive, and the eutectic cells may not be present. Further details regarding exemplary alumina-zirconia materials can be found in co-pending application having U.S. Ser. No. ______ (Attorney Docket No. 58797US002), filed the same date as the instant application, the disclosure of which is incorporated herein by reference.

In some embodiments, carbon impurities that may be in fused, polycrystalline ceramic abrasive particles according to the present invention are not greater than 1 (in some embodiments, not greater than 0.5, or even not greater than 0.25) percent by weight, based on the total weight of the respective abrasive particle. Other impurities that may be present in fused, polycrystalline ceramic abrasive particles include silica, iron oxides, titania, and their reaction products.

The microstructure or phase composition of a material can be determined, for example, using electron microscopy and x-ray diffraction (XRD). Using powder x-ray diffraction, XRD, (using an x-ray diffractometer such as that obtained under the trade designation “PHILLIPS XRG 3100” from Phillips, Mahwah, N.J., with copper K α1 radiation of 1.54050 Angstrom) the phases present in a material can be determined by comparing the peaks present in the XRD trace of the crystallized material to XRD patterns of crystalline phases provided in JCPDS (Joint Committee on Powder Diffraction Standards) databases, published by International Center for Diffraction Data. Examples of crystalline phases which may be present in fused, polycrystalline ceramic abrasive particles provided by the present invention include: Al₂O₃ (e.g., alpha alumina and transition alumina), ZrO₂ (e.g., cubic and tetragonal ZrO₂), REO, Y₂O₃, MgO, BaO, CaO, Cr₂O₃, CoO, Fe₂O₃, GeO₂, Li₂O, MnO, NiO, Na₂O, P₂O₅, Sc₂O₃, SiO₂, SrO, TeO₂, TiO₂, V₂O₅, ZnO, HfO₂, as well as “complex metal oxides” (including complex Al₂O₃.metal oxide (e.g., complex Al₂O₃.REO)), complex Al₂O₃.metal oxide(s) (e.g., complex Al₂O₃.REO (e.g., ReAlO₃ (e.g., GdAlO₃ LaAlO₃), ReAl₁₁O₁₈ (e.g., LaAl₁₁O₁₈,), and Re₃Al₅O₁₂ (e.g., Dy₃Al₅O₁₂)), complex Al₂O₃.Y₂O₃ (e.g., Y₃Al₅O₁₂), and complex ZrO₂.REO (e.g., La₂Zr₂O₇), and combinations thereof.

In some embodiments, essentially all (i.e., at least 75 (in some embodiments, at least 80, 85, 90, or even 100) percent by volume) of any ZrO₂ that is present is in the cubic and/or tetragonal modification. Although not wanting to be bound by theory, it is believed that typically higher cooling rates, smaller ZrO₂ crystals and/or the presence of stabilizing oxides promote higher amounts of tetragonal/cubic zirconia in the fused, polycrystalline ceramic abrasive particles according to the present invention.

It is also with in the scope of the present invention to substitute a portion of the aluminum cations in a complex Al₂O₃.metal oxide (e.g., complex Al₂O₃REO and/or complex Al₂O₃.Y₂O₃ (e.g., yttrium aluminate exhibiting a garnet crystal structure)) with other cations. For example, a portion of the Al cations in a complex Al₂O₃.Y₂O₃ may be substituted with at least one cation of an element selected from the group consisting of: Cr, Ti, Sc, Fe, Mg, Ca, Si, Co, and combinations thereof. For example, a portion of the Y cations in a complex Al₂O₃.Y₂O₃ may be substituted with at least one cation of an element selected from the group consisting of: Ce, Dy, Er, Eu, Gd, Ho, La, Lu, Nd, Pr, Sm, Th, Tm, Yb, Fe, Ti, Mn, V, Cr, Co, Ni, Cu, Mg, Ca, Sr, and combinations thereof. Further, for example, a portion of the rare earth cations in a complex Al₂O₃.REO may be substituted with at least one cation of an element selected from the group consisting of: Y, Fe, Ti, Mn, V, Cr, Co, Ni, Cu, Mg, Ca, Sr, and combinations thereof. The substitution of cations as described above may affect the properties (e.g. hardness, toughness, strength, thermal conductivity, etc.) of fused, polycrystalline ceramic abrasive particle according to the present invention.

The average crystal size can be determined by the line intercept method according to the ASTM standard E 112-96 “Standard Test Methods for Determining Average Grain Size”. The sample is mounted in mounting resin (such as that obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (such as that obtained from Buehler, Lake Bluff, Ill. under the trade designation “ECOMET 3”). The sample is polished for about 3 minutes with a diamond wheel containing 125-micrometer diamonds, followed by 5 minutes of polishing with each of 45, 30, 15, 9, 3, and 1-micrometer slurries. The mounted and polished sample is sputtered with a thin layer of gold-palladium and viewed using a scanning electron microscopy (such as Model JSM 840A from JEOL, Peabody, Mass.). A typical back-scattered electron (BSE) photomicrograph of the microstructure found in the sample is used to determine the average crystallite size as follows. The number of crystallites that intersect per unit length (N_{L}) of a random straight line drawn across the photomicrograph are counted. The average crystallite size is determined from this number using the following equation.

$$Average Crystallite Size = \frac{15}{{N}_{L} M} ,$$

where N_{L} is the number of crystallites intersected per unit length and M is the magnification of the photomicrograph.

Fused, polycrystalline ceramic abrasive particles according to the present invention exhibit a variety of microstructures depending, for example, on the exact composition, quench rate and/or properties of the feed material. Compositions near a eutectic typically exhibit microstructures comprising eutectic laminar structures of corresponding crystalline phases, for example, alumina and complex Al₂O₃.Y₂O₃, such as yttrium aluminum garnet, YAG. Compositions outside of the eutectic compositions typically include primary crystals of a phase along with the eutectic laminar structures of the corresponding crystalline phases. The primary crystals may take a variety of forms including dendritic, faceted, spherical, etc. Typically the size of the primary crystals is determined by the cooling rate. The primary crystals present in some fused polycrystalline materials according to the present invention have sizes less than 10 micrometers, 5 micrometers, 3 micrometers, 2 micrometers, or even less than 1 micrometer. Typically, the primary crystals have sizes in a range from 1 micrometer to 10 micrometers (in some embodiments, in a range from 1 micrometer to 5 micrometers, 1 micrometer to 3 micrometers, or even at least 1 micrometer to 2 micrometers.

For compositions that do not form eutectics, the microstructure typically includes crystals of thermodynamically stable or metastable phases. Typically the sizes of the crystals, as well as the type and nature of crystalline phases present are determined by the cooling rate and the composition. The crystals may take a variety of forms including dendritic, faceted, spherical, etc. The crystals present in some fused polycrystalline materials according to the present invention have sizes less than 10 micrometers, 5 micrometers, 3 micrometers, 2 micrometers, or even less than 1 micrometer. Typically, the crystals have sizes in a range from 1 micrometer to 10 micrometers (in some, embodiments, in a range from 1 micrometer to 5 micrometers, 1 micrometer to, 3 micrometers, or even in a range from 1 micrometer to 2 micrometers.

The average hardness of the fused, polycrystalline ceramic abrasive particles according to the present invention can be determined as follows. Sections of the material are mounted in mounting resin (obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (such as that obtained from Buehler, Lake Bluff, Ill. under the trade designation “ECOMET 3”). The sample is polished for about 3 minutes with a diamond wheel containing 125-micrometer diamonds, followed by 5 minutes of polishing with each of 45, 30, 15, 9, 3, and 1-micrometer slurries. The microhardness measurements are made using a conventional microhardness tester (such as that obtained under the trade designation “MITUTOYO MVK-VL” from Mitutoyo Corporation, Tokyo, Japan) fitted with a Vickers indenter using a 100-gram indent load. The microhardness measurements are made according to the guidelines stated in ASTM Test Method E384 Test Methods for Microhardness of Materials (1991). The average hardness is an average of 10 measurements.

Abrasive particles made by the present invention have an average hardness of at least 14 GPa, in some embodiments, at least 15 GPa, 16 GPa, or even at least 17 GPa Abrasive particles made according to the present invention have densities of at least 75% (in some embodiments, at least 80%, 85%, 90%, 92%, 95%, 96%, 97%, 98%, 99%, 99.5%, or even 100%) of theoretical density.

Fused, polycrystalline ceramic abrasive particles made according to the present invention can be screened and graded using techniques well known in the art, including the use of industry recognized grading standards such as ANSI (American National Standard Institute), FEPA (Federation Europeenne des Fabricants de Products Abrasifs), and JIS (Japanese Industrial Standard). However, since the fused, polycrystalline ceramic abrasive particles as made may already have a narrow particle size distribution (e.g., essentially all of the particles may have the same size), graded may not be necessary to obtain the desired distribution of particles.

The abrasive particles may be used in a wide range of particle sizes, typically ranging in size from about 0.1 to about 5000 micrometers, 1 to about 2000 micrometers, about 5 to about 1500 micrometers, or even in some embodiments, from about 50 to 1000, or even from about 100 to about 1000 micrometers.

In a given particle size distribution, there will be a range of particle sizes, from coarse particles fine particles. In the abrasive art this range is sometimes referred to as a “coarse”, “control”, and “fine” fractions. Abrasive particles graded according to abrasive industry accepted grading standards specify the particle size distribution for each nominal grade within numerical limits. Such industry accepted grading standards include those known as the American National Standards Institute, Inc. (ANSI) standards, Federation of European Producers of Abrasive Products (FEPA) standards, and Japanese Industrial Standard (JIS) standards. ANSI grade designations (i.e., specified nominal grades) include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. FEPA grade designations include P8, P12, P16, P24, P36, P40, P50, P60, P80, P100, P120, P150, P180, P220, P320, P400, P500, P600, P800, P1000, and P1200. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10,000.

After screening, there will typically be a multitude of different abrasive particle size distributions or grades. These multitudes of grades may not match a manufacturer's or supplier's needs at that particular time. To minimize inventory, it is possible to recycle the off demand grades back into melt for making fused, polycrystalline ceramic material according to the present invention. This recycling may occur after the crushing step, where the particles are in large chunks or smaller pieces (sometimes referred to as “fines”) that have not been screened to a particular distribution.

In another aspect, the present invention provides agglomerate abrasive grains each comprising a plurality of fused, polycrystalline ceramic abrasive particles made according to the present invention bonded together via a binder. In another aspect, the present invention provides an abrasive article.(e.g., coated abrasive articles, bonded abrasive articles (including vitrified, resinoid; and metal bonded grinding wheels, cutoff wheels, mounted points, and honing stones), nonwoven abrasive articles, and abrasive brushes) comprising a binder and a plurality of abrasive particles, wherein at least a portion of the abrasive particles are fused, polycrystalline ceramic abrasive particles (including where the abrasive particles are agglomerated) made according to the present invention. Methods of making such abrasive articles and using abrasive articles are well known to those skilled in the art. Furthermore, fused, polycrystalline ceramic abrasive particles made according to the present invention can be used in abrasive applications that utilize abrasive particles, such as slurries of abrading compounds (e.g., polishing compounds), milling media, shot blast media, vibratory mill media, and the like.

Coated abrasive articles generally include a backing, abrasive particles, and at least one binder to hold the abrasive particles onto the backing. The backing can be any suitable material, including cloth, polymeric film, fibre, nonwoven webs, paper, combinations thereof, and treated versions thereof. Suitable binders includes inorganic or organic binders (including thermally curable resins and radiation curable resins). The abrasive particles can be present in one layer or in two layers of the coated abrasive article.

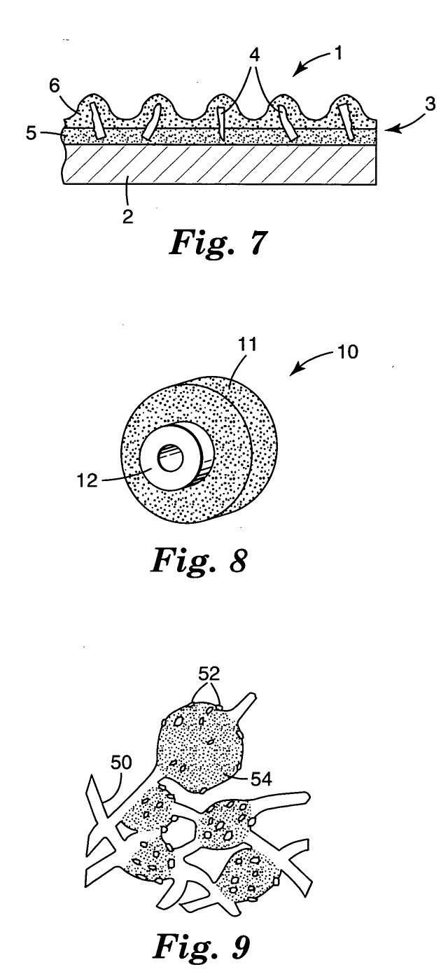

An example of a coated abrasive article is depicted in FIG. 7. Referring to FIG. 7, coated abrasive article 1 has a backing (substrate) 2 and abrasive layer 3. Abrasive layer 3 includes fused, polycrystalline ceramic abrasive particles made according to the present invention 4 secured to a major surface of backing 2 by make coat 5 and size coat 6. In some instances, a supersize coat (not shown) is used.

Bonded abrasive articles typically include a shaped mass of abrasive particles held together by an organic, metallic, or vitrified binder. Such shaped mass can be, for example, in the form of a wheel, such as a grinding wheel or cutoff wheel. The diameter of grinding wheels typically is about 1 cm to over 1 meter; the diameter of cut off wheels about 1 cm to over 80 cm (more typically 3 cm to about 50 cm). The cut off wheel thickness is typically about 0.5 mm to about 5 cm, more typically about 0.5 mm to about 2 cm. The shaped mass can also be in the form, for example, of a honing stone, segment, mounted point, disc (e.g. double disc grinder) or other conventional bonded abrasive shape. Bonded abrasive articles typically comprise about 3-50% by volume bond material, about 30-90% by volume abrasive particles (or abrasive particle blends), up to 50% by volume additives (including grinding aids), and up to 70% by volume pores, based on the total volume of the bonded abrasive article.

An exemplary grinding wheel is shown in FIG. 8. Referring to FIG. 8, grinding wheel 10 is depicted, which includes fused, polycrystalline ceramic abrasive particles made according to the present invention 11, molded in a wheel and mounted on hub 12.

Nonwoven abrasive articles typically include an open porous lofty polymer filament structure having fused, polycrystalline ceramic abrasive particles made according to the present invention distributed throughout the structure and adherently bonded therein by an organic binder. Examples of filaments include polyester fibers, polyamide fibers, and polyaramid fibers. An exemplary nonwoven abrasive article is shown in FIG. 9. Referring to FIG. 9, a schematic depiction, enlarged about 100×, of a typical nonwoven abrasive article is shown, comprises fibrous mat 150 as a substrate, onto which fused, polycrystalline ceramic abrasive particles made according to the present invention 152 are adhered by binder 154.

Useful abrasive brushes include those having a plurality of bristles unitary with a backing (see, e.g., U.S. Pat. No. 5,427,595 (Pihl et al.), U.S. Pat. No. 5,443,906 (Pihl et al.), U.S. Pat. No. 5,679,067 (Johnson et al.), and U.S. Pat. No. 5,903,951 (Ionta et al.)). Desirably, such brushes are made by injection molding a mixture of polymer and abrasive particles.

Suitable organic binders for making abrasive articles include thermosetting organic polymers. Examples of suitable thermosetting organic polymers include phenolic resins, urea-formaldehyde resins, melamine-formaldehyde resins, urethane resins, acrylate resins, polyester resins, aminoplast resins having pendant α,β-unsaturated carbonyl groups, epoxy resins, acrylated urethane, acrylated epoxies, and combinations thereof. The binder and/or abrasive article may also include additives such as fibers, lubricants, wetting agents, thixotropic materials, surfactants, pigments, dyes, antistatic agents (e.g., carbon black, vanadium oxide, graphite, etc.), coupling agents (e.g., silanes, titanates, zircoaluminates, etc.), plasticizers, suspending agents, and the like. The amounts of these optional additives are selected to provide the desired properties. The coupling agents can improve adhesion to the abrasive particles and/or filler. The binder chemistry may be thermally cured, radiation cured or combinations thereof. Additional details on binder chemistry may be found in U.S. Pat. No. 4,588,419 (Caul et al.), U.S. Pat. No. 4,751,138 (Tumey et al.), and U.S. Pat. No. 5,436,063 (Follett et al.).

More specifically with regard to vitrified bonded abrasives, vitreous bonding materials, which exhibit an amorphous structure and are typically hard, are well known in the art. In some cases, the vitreous bonding material includes crystalline phases. Bonded, vitrified abrasive articles made according to the present invention may be in the shape of a wheel (including cut off wheels), honing stone, mounted pointed or other conventional bonded abrasive shape. In some embodiments, a vitrified bonded abrasive article made according to the present invention is in the form of a grinding wheel.

Examples of metal oxides that are used to form vitreous bonding materials include: silica, silicates, alumina, soda, calcia, potassia, titania, iron oxide, zinc oxide, lithium oxide, magnesia, boria, aluminum silicate, borosilicate glass, lithium aluminum silicate, combinations thereof, and the like. Typically, vitreous bonding materials can be formed from composition comprising from 10% to 100% glass frit, although more typically the composition comprises 20% to 80% glass frit, or 30% to 70% glass frit. The remaining portion of the vitreous bonding material can be a non-frit material. Alternatively, the vitreous bond may be derived from a non-frit containing composition. Vitreous bonding materials are typically matured at a temperature(s) in a range of about 700° C. to about 1500° C., usually in a range of about 800° C. to about 1300° C., sometimes in a range of about 900° C. to about 1200° C., or even in a range of about 950° C. to about 1100° C. The actual temperature at which the bond is matured depends, for example, on the particular bond chemistry.

In some embodiments, vitrified bonding materials include those comprising silica, alumina (desirably, at least 10 percent by weight alumina), and boria (desirably, at least 10 percent by weight boria). In most cases the vitrified bonding material further comprise alkali metal oxide(s) (e.g., Na₂O and K₂O) (in some cases at least 10 percent by weight alkali metal oxide(s)).

Binder materials may also contain filler materials or grinding aids, typically in the form of a particulate material. Typically, the particulate materials are inorganic materials. Examples of useful fillers for this invention include: metal carbonates (e.g., calcium carbonate (e.g., chalk, calcite, marl, travertine, marble and limestone), calcium magnesium carbonate, sodium carbonate, magnesium carbonate), silica (e.g., quartz, glass beads, glass bubbles and glass fibers) silicates (e.g., talc, clays, (montmorillonite) feldspar, mica, calcium silicate, calcium metasilicate, sodium aluminosilicate, sodium silicate) metal sulfates (e.g., calcium sulfate, barium sulfate, sodium sulfate, aluminum sodium sulfate, aluminum sulfate), gypsum, vermiculite, wood flour, aluminum trihydrate, carbon black, metal oxides (e.g., calcium oxide (lime), aluminum oxide, titanium dioxide), and metal sulfites (e.g., calcium sulfite).

In general, the addition of a grinding aid increases the useful life of the abrasive article. A grinding aid is a material that has a significant effect on the chemical and physical processes of abrading, which results in improved performance. Although not wanting to be bound by theory, it is believed that a grinding aid(s) will (a) decrease the friction between the abrasive particles and the workpiece being abraded, (b) prevent the abrasive particles from “capping” (i.e., prevent metal particles from becoming welded to the tops of the abrasive particles), or at least reduce the tendency of abrasive particles to cap, (c) decrease the interface temperature between the abrasive particles and the workpiece, or (d) decreases the grinding forces.

Grinding aids encompass a wide variety of different materials and can be inorganic or organic based. Examples of chemical groups of grinding aids include waxes, organic halide compounds, halide salts and metals and their alloys. The organic halide compounds will typically break down during abrading and release a halogen acid or a gaseous halide compound. Examples of such materials include chlorinated waxes like tetrachloronaphtalene, pentachloronaphthalene, and polyvinyl chloride. Examples of halide salts include sodium chloride, potassium cryolite, sodium cryolite, ammonium cryolite, potassium tetrafluoroboate, sodium tetrafluoroborate, silicon fluorides, potassium chloride, and magnesium chloride. Examples of metals include, tin, lead, bismuth, cobalt, antimony, cadmium, and iron titanium. Other miscellaneous grinding aids include sulfur, organic sulfur compounds, graphite, and metallic sulfides. It is also within the scope of the present invention to use a combination of different grinding aids, and in some instances this may produce a synergistic effect.

Grinding aids can be particularly useful in coated abrasive and bonded abrasive articles. In coated abrasive articles, grinding aid is typically used in the supersize coat, which is applied over the surface of the abrasive particles. Sometimes, however, the grinding aid is added to the size coat. Typically, the amount of grinding aid incorporated into coated abrasive articles are about 50-300 g/m² (desirably, about 80-160 g/m²). In vitrified bonded abrasive articles grinding aid is typically impregnated into the pores of the article.

The abrasive articles can contain 100% fused, polycrystalline ceramic abrasive particles made according to the present invention, or blends of such abrasive particles with other abrasive particles and/or diluent particles. However, at least about 2% by weight, desirably at least about 5% by weight, and more desirably about 30-100% by weight, of the abrasive particles in the abrasive articles should be fused, polycrystalline ceramic abrasive particles made according to the present invention. In some instances, the abrasive particles made according to the present invention may be blended with another abrasive particles and/or diluent particles at a ratio between 5 to 75% by weight, about 25 to 75% by weight about 40 to 60% by weight, or about 50% to 50% by weight (i.e., in equal amounts by weight). Examples of suitable conventional abrasive particles include fused aluminum oxide (including white fused alumina, heat-treated aluminum oxide and brown aluminum oxide), silicon carbide, boron carbide, titanium carbide, diamond, cubic boron nitride, garnet, fused alumina-zirconia, and sol-gel-derived abrasive particles, and the like. The sol-gel-derived abrasive particles may be seeded or non-seeded. Likewise, the sol-gel-derived abrasive particles may be randomly shaped or have a shape associated with them, such as a rod or a triangle. Examples of sol gel abrasive particles include those described in U.S. Pat. No. 4,314,827 (Leitheiser et al.), U.S. Pat. No. 4,518,397 (Leitheiser et al.), U.S. Pat. No. 4,623,364 (Cottringer et al.), U.S. Pat. No. 4,744,802 (Schwabel), U.S. Pat. No. 4,770,671 (Monroe et al.), U.S. Pat. No. 4,881,951 (Wood et al.), U.S. Pat. No. 5,011,508 (Wald et al.), U.S. Pat. No. 5,090,968 (Pellow), U.S. Pat. No. 5,139,978 (Wood), U.S. Pat. No. 5,201,916 (Berg et al.), U.S. Pat. No. 5,227,104 (Bauer), U.S. Pat. No. 5,366,523 (Rowenhorst et al.), U.S. Pat. No. 5,429,647 (Larmie), U.S. Pat. No. 5,498,269 (Larmie), and U.S. Pat. No. 5,551,963 (Larmie). Additional details concerning sintered alumina abrasive particles made by using alumina powders as a raw material source can also be found, for example, in U.S. Pat. No. 5,259,147 (Falz), U.S. Pat. No. 5,593,467 (Monroe), and U.S. Pat. No. 5,665,127 (Moltgen). Additional details concerning fused abrasive particles, can be found, for example, in U.S. Pat. No. 1,161,620 (Coulter), U.S. Pat. No. 1,192,709 (Tone), U.S. Pat. No. 1,247,337 (Saunders et al.) U.S. Pat. No. 1,268,533 (Allen), and U.S. Pat. No. 2,424,645 (Baumann et al.), U.S. Pat. No. 3,891,408 (Rowse et al.), U.S. Pat. No. 3,781,172 (Pett et al.), U.S. Pat. No. 3,893,826 (Quinan et al.), U.S. Pat. No. 4,126,429 (Watson), U.S. Pat. No. 4,457,767 (Poon et al.), U.S. Pat. No. 5,023,212 (Dubots et al.), U.S. Pat. No. 5,143,522 (Gibson et al.), and U.S. Pat. No. 5,336,280 (Dubots et al.), and applications having U.S. Ser. Nos. 09/495,978, 09/496,422, 09/496,638, and 09/496,713, each filed on Feb. 2, 2000; and Ser. Nos. 09/618,876, 09/618,879, 09/619,106, 09/619,191, 09/619,192, 09/619,215, 09/619,289, 09/619,563, 09/619,729, 09/619,744, and 09/620,262, each filed on Jul. 19, 2000, Ser. No. 09/704,843, filed Nov. 2, 2000; and Ser. No. 09/772,730, filed Jan. 30, 2001. Additional details regarding ceramic abrasive particles, can be found, for example, in applications having U.S. Ser. Nos. 09/922,526, 09/922,527, 09/922,528, and 09/922,530, each filed Aug. 2, 2001, now abandoned, Ser. Nos. 10/211,597, 10/211,638, 10/211,629, 10/211,598, 10/211,630, 10/211,639, 10/211,034, 10/211,044, 10/211,628, 10/211,491, 10/211,640, and 10/211,684, each filed Aug. 2, 2002 and Ser. Nos. 10/358,772, 10/358,765, 10/358,910, 10/358,855, and 10/358,708, each filed Feb. 5, 2003. In some instances, blends of abrasive particles may result in an abrasive article that exhibits improved grinding performance in comparison with abrasive articles comprising 100% of either type of abrasive particle.

If there is a blend of abrasive particles, the abrasive particle types forming the blend may be of the same size. Alternatively, the abrasive particle types may be of different particle sizes. For example, the larger sized abrasive particles may be fused, polycrystalline ceramic abrasive particles made according to the present invention, with the smaller sized particles being another abrasive particle type. Conversely, for example, the smaller sized abrasive particles may be fused, polycrystalline ceramic abrasive particles made according to the present invention, with the larger sized particles being another abrasive particle type.

Examples of suitable diluent particles include marble, gypsum, flint, silica, iron oxide, aluminum silicate, glass (including glass bubbles and glass beads), alumina bubbles, alumina beads and diluent agglomerates.

Fused, polycrystalline ceramic abrasive particles according to the present invention can also be combined in or with abrasive agglomerates. Abrasive agglomerate particles typically comprise a plurality of abrasive particles, a binder, and optional additives. The binder may be organic and/or inorganic. Abrasive agglomerates may be randomly shape or have a predetermined shape associated with them. The shape may be a block, cylinder, pyramid, coin, square, or the like. Abrasive agglomerate particles typically have particle sizes ranging from about 100 to about 5000 micrometers, typically about 250 to about 2500 micrometers. Additional details regarding abrasive agglomerate particles may be found, for example, in U.S. Pat. No. 4,311,489 (Kressner), U.S. Pat. No. 4,652,275 (Bloecher et al.), U.S. Pat. No. 4,799,939 (Bloecher et al.), U.S. Pat. No. 5,549,962 (Holmes et al.), and U.S. Pat. No. 5,975,988 (Christianson), and applications having U.S. Ser. Nos. 09/688,444 and 09/688,484; each filed Oct. 16, 2000, Ser. Nos. 09/688,444, 09/688,484, and 09/688,486, each filed Oct. 16, 2000; and Ser. Nos. 09/971,899, 09/972,315, and 09/972,316, each filed Oct. 5, 2001.

The abrasive particles may be uniformly distributed in the abrasive article or concentrated in selected areas or portions of the abrasive article. For example, in a coated abrasive, there may be two layers of abrasive particles. The first layer comprises abrasive particles other than fused, polycrystalline ceramic abrasive particles made according to the present invention, and the second (outermost) layer comprises fused, polycrystalline ceramic abrasive particles made according to the present invention. Likewise in a bonded abrasive, there may be two distinct sections of the grinding wheel. The outermost section may comprise abrasive particles made according to the present invention, whereas the innermost section does not. Alternatively, fused, polycrystalline ceramic abrasive particles made according to the present invention may be uniformly distributed throughout the bonded abrasive article.

Further details regarding coated abrasive articles can be found, for example, in U.S. Pat. No. 4,734,104 (Broberg), U.S. Pat. No. 4,737,163 (Larkey), U.S. Pat. No. 5,203,884 (Buchanan et al.), U.S. Pat. No. 5,152,917 (Pieper et al.), U.S. Pat. No. 5,378,251 (Culler et al.), U.S. Pat. No. 5,417,726 (Stout et al.), U.S. Pat. No. 5,436,063 (Follett et al.), U.S. Pat. No. 5,496,386 (Broberg et al.), U.S. Pat. No. 5,609,706 (Benedict et al.), U.S. Pat. No. 5,520,711 (Helmin), U.S. Pat. No. 5,954,844 (Law et al.), U.S. Pat. No. 5,961,674 (Gagliardi et al.), and U.S. Pat. No. 5,975,988 (Christianson). Further details regarding bonded abrasive articles can be found, for example, in U.S. Pat. No. 4,543,107 (Rue), U.S. Pat. No. 4,741,743 (Narayanan et al.), U.S. Pat. No. 4,800,685 (Haynes et al.), U.S. Pat. No. 4,898,597 (Hay et al.), U.S. Pat. No. 4,997,461 (Markhoff-Matheny et al.), U.S. Pat. No. 5,037,453 (Narayanan et al.), U.S. Pat. No. 5,110,332 (Narayanan et al.), and U.S. Pat. No. 5,863,308 (Qi et al.). Further details regarding vitreous bonded abrasives can be found, for example, in U.S. Pat. No. 4,543,107 (Rue), U.S. Pat. No. 4,898,597 (Hay et al.), U.S. Pat. No. 4,997,461 (Markhoff-Matheny et al.), U.S. Pat. No. 5,094,672 (Giles Jr. et al.), U.S. Pat. No. 5,118,326 (Sheldon et al.), U.S. Pat. No. 5,131,926 (Sheldon et al.), U.S. Pat. No. 5,203,886 (Sheldon et al.), U.S. Pat. No. 5,282,875 (Wood et al.), U.S. Pat. No. 5,738,696 (Wu et al.), and U.S. Pat. No. 5,863,308 (Qi). Further details regarding nonwoven abrasive articles can be found, for example, in U.S. Pat. No. 2,958,593 (Hoover et al.).

The present invention provides a method of abrading a surface, the method comprising contacting at least one fused, polycrystalline ceramic abrasive particle made according to the present invention, with a surface of a workpiece; and moving at least of one the fused, polycrystalline ceramic abrasive particles or the contacted surface to abrade at least a portion of said surface with the abrasive particle. Methods for abrading with fused, polycrystalline ceramic abrasive particles made according to the present invention range from snagging (i.e., high pressure high stock removal) to polishing (e.g., polishing medical implants with coated abrasive belts), wherein the latter is typically done with finer grades (e.g., ANSI 220 and finer) of abrasive particles. The fused, polycrystalline ceramic abrasive particles may also be used in precision abrading applications, such as grinding cam shafts with vitrified bonded wheels. The size of the abrasive particles used for a particular abrading application will be apparent to those skilled in the art.

Abrading with fused, polycrystalline ceramic abrasive particles made according to the present invention may be done dry or wet. For wet abrading, the liquid may be introduced supplied in the form of a light mist to complete flood. Examples of commonly used liquids include: water, water-soluble oil, organic lubricant, and emulsions. The liquid may serve to reduce the heat associated with abrading and/or act as a lubricant. The liquid may contain minor amounts of additives such as bactericide, antifoaming agents, and the like.

Fused, polycrystalline ceramic abrasive particles made according to the present invention may be useful, for example, to abrade workpieces such as aluminum metal, carbon steels, mild steels, tool steels, stainless steel, hardened steel, titanium, glass, ceramics, wood, wood-like materials (e.g., plywood and particle board), paint, painted surfaces, organic coated surfaces and the like. The applied force during abrading typically ranges from about 1 to about 100 kilograms.

Advantages and embodiments of this invention are further illustrated by the following non-limiting examples, but the particular materials and amounts thereof recited in these examples, as well as other conditions and details, should not be construed to unduly limit this invention. All parts and percentages are by weight unless otherwise indicated.

### EXAMPLE 1

A 250-ml polyethylene bottle (7.3-cm diameter) was charged with 64 grams aluminum oxide powder (obtained from Alcoa Industrial Chemicals, Bauxite, Ariz., under the trade designation “Al6SG”), 36 grams yttrium oxide powder (obtained from Molycorp, Inc., Brea, Calif.), 100 grams of water and 200 grams of alumina milling media (cylindrical shape, both height and diameter of 0.635 cm; 99.9% alumina; obtained from Coors, Golden, Colo.). The contents of the polyethylene bottle were milled for 16 hours at 60 revolutions per minute (rpm). After the milling, the milling media were removed and the slurry was poured onto a warm (about 75° C.) glass (“PYREX”) pan in a layer, and allowed to cool and dry in an oven at 110° C. The dried mixture was ground by screening through a 30-mesh screen (600-micrometer opening size) with the aid of a paintbrush and pre-sintered at 1325° C., in air, for two hours in an electrically heated furnace (obtained from CM Furnaces, Bloomfield, N.J. under the trade designation “Rapid Temp Furnace”).

The sintered mixture was graded to retain the −80+100 mesh fraction (i.e., the fraction collected between 180 micrometer opening size and 150 micrometer opening size screens, with a mean particle size of about 165 micrometer). The resulting screened particles were fed slowly (about 0.5 gram/minute) through a funnel, which was attached to a powder feeder, under a nitrogen gas atmosphere 5 standard liter per minute (SLPM), into a hydrogen/oxygen torch flame which melted the particles and carried them directly into a 19-liter (5-gallon) rectangular container (41 centimeters (cm) by 53 cm by 18 cm height) of continuously circulating, turbulent water (20° C.) to rapidly quench the molten droplets. The powder feeder comprised a canister (8 cm diameter) at the bottom of which was a 70-mesh screen (212 micrometer opening size). The particular powder feeder used is that illustrated in FIGS. 1-6, as described above, wherein the screens were made from stainless steel (available from W.S. Tyler Inc., Mentor, Ohio). The powder was filled into the canister and was forced through the openings of the screen using a rotating brush. The torch was a Bethlehem bench burner PM2D Model B obtained from Bethlehem Apparatus Co., Hellertown, Pa. The torch had a central feed port (0.475 cm (3/16 inch) inner diameter) through which the feed particles were introduced into the flame. Hydrogen and oxygen flow rates for the torch were as follows. The hydrogen flow rate was 42 standard liters per minute (SLPM) and the oxygen flow rate was 18 SLPM. The angle at which the flame hit the water was approximately 90°, and the flame length, burner to water surface, was approximately 38 centimeters (cm). The resulting (quenched) particles were collected in a pan and heated at 110° C. in an electrically heated furnace till dried (about 30 minutes). The particles were spherical in shape and varied in size from 100 micrometer up to 180 micrometer, with a mean particle size of about 145 micrometer.

A percent crystalline yield was calculated from the resulting flame formed beads. The measurements were done as follows. A single layer of beads was spread out upon a glass slide. The beads were observed at 32× using an optical microscope. Using the crosshairs in the optical microscope eyepiece as a guide, beads that lay horizontally coincident with crosshair along a straight line were counted either transparent or opaque (i.e., crystalline) depending on their optical clarity. A total of 500 beads were counted and a percent crystalline yield was determined by the number of opaque beads divided by total beads counted and multiplied by 100. The particles were predominantly opaque (>90% by number).

Powder X-ray diffraction, XRD, (using an X-ray diffractometer (obtained under the trade designation “PHILLIPS XRG 3100” from Phillips, Mahwah, N.J.) with copper K α1 radiation of 1.54050 Angstrom) was used to determine the phases present in the crystalline Example 1 particles. The phases were determined by comparing the peaks present in the XRD trace of the crystallized material to XRD patterns of crystalline phases provided in JCPDS databases, published by International Center for Diffraction Data. The crystalline phases identified for the Example 1 material were yttria-alumina crystals exhibiting a garnet crystal structure (YAG) and a mixture of alpha and gamma-Al₂O₃ phases.

A sample was prepared for microstructure analysis in the following method. About 1 gram of the Example 1 particles was mounted in mounting resin (obtained under the trade designation “TRANSOPTIC POWDER” from Buehler, Lake Bluff, Ill.). The resulting cylinder of resin was about 2.5 cm in diameter and about 1.9 cm high. The mounted section was prepared using conventional polishing techniques using a polisher (obtained from Buehler, Lake Bluff, Ill. under the trade designation “ECOMET 3”). The sample was polished for about 3 minutes with a diamond wheel containing 125-micrometer diamonds, followed by 5 minutes of polishing with each of 45, 30, 15, 9, 3, and 1-micrometer slurries. The mounted and polished sample was coated with a thin layer of gold-palladium and viewed using a JEOL SEM (Model JSM 840A).

FIG. 10 is a scanning electron microscope (SEM) electronphotomicrograph of a polished section of Example 1 material. The microstructure of Example 1 material was observed to be made up of dendritic growth of YAG crystals in a matrix of aluminum oxide. Eutectic structure was not visible within the matrix when viewed at a magnification of 12,000 times. The average size of the dendritic YAG crystals was determined by using the line intercept method. A back-scattered electron (BSE) photomicrograph of the microstructure was used to determine the average crystallite size as follows. The number of crystallites that intersect per unit length (N_{L}) of a random straight line drawn across the photomicrograph are counted. The average crystallite size is determined from this number using the following equation.

$$Average Crystallite Size = \frac{15}{{N}_{L} M} ,$$

where N_{L} is the number of crystallites intersected per unit length and M is the magnification of the photomicrograph. The dendritic YAG crystals had an average diameter of about 1.5 micrometer.

The average hardness of the crystalline particles of this example was determined as follows. Using the same method as described for microstructure evaluation, about 1 gram of beads was mounted and polished. The microhardness measurements were made using a conventional microhardness tester (obtained under the trade designation “MITUTOYO MVK-VL” from Mitutoyo Corporation, Tokyo, Japan) fitted with a Vickers indenter using a 200-gram indent load. The microhardness measurements were made according to the guidelines stated in ASTM Test Method E384 Test Methods for Microhardness of Materials (1991), the disclosure of which is incorporated herein by reference. The average microhardness (an average of 10 measurements) of the material of this example was 9.8 GPa.

### EXAMPLE 2

Example 2 particles were prepared as described in Example 1, except the amounts of raw materials used were 50 grams of alumina particles (“Al6SG”), 50 grams of yttrium oxide particles (obtained from Molycorp, Inc.), 1 gram of methyl cellulose (Methocel A4M; obtained from Dow Chemical, Midland, Mich.), 100 grams of water and 200 grams of alumina milling media (cylindrical shape, both height and diameter of 0.635 cm; 99.9% alumina; obtained from Coors). In addition, the graded feed particles were not pre-sintered before the flame forming operation. For the flame forming, the feed particles had sizes in the range −45+60 mesh, (i.e., the fraction collected between 250 micrometer opening size and 355 micrometer opening size screens, with a mean particle size of about 300 micrometer).

The flame formed particles were spherical in shape and varied in size from about 210 micrometer up to about 300 micrometer, with a mean particle size of about 250 micrometer.

The crystalline phase content of the Example 2 material was determined by XRD as described in Example 1. The crystalline phases identified for the Example 2 material were YAG, and a mixture of gamma (trace) and alpha-Al₂O₃ phases.

The microstructure of the Example 2 materials was analyzed using the SEM as described in Example 1. The microstructure of the material was observed to be made up of primary crystals of YAG in a eutectic matrix comprising YAG and alumina. The primary YAG crystals appeared either rod-like or in a more equiaxed shapes and were arranged in a dendritic growth pattern. The microstructure between the primary YAG crystals was characteristic eutectic structure with no discernable cells.

Hardness was measured as described for Example 1, and was 8.9 GPa.

### EXAMPLE 3

Example 3 particles were prepared as described in Example 2, except the amounts of raw materials used were 66 grams of alumina particles (“Al6SG”), 34 grams of yttrium oxide particles (obtained from Molycorp, Inc.), 1 gram of methyl cellulose (Methocel A4M; obtained from Dow Chemical), 100 grams of water, and 200 grams of alumina milling media (cylindrical shape, both height and diameter of 0.635 cm; 99.9% alumina; obtained from Coors).

The flame formed particles were spherical in shape and varied in size from about 210 micrometer up to about 300 micrometer, with a mean particle size of about 250 micrometer.

The crystalline phase content of the Example 2 material was determined by XRD as described in Example 1. The crystalline phases identified for the Example 3 material were YAG, and a mixture of gamma (trace) and alpha-Al₂O₃ phases.

The microstructure of the Example 3 material was analyzed using the SEM as described in Example 1. The microstructure of the material was observed to be made up of primary crystals of alumina in a eutectic matrix comprising YAG and alumina. The primary alumina crystals were equiaxed, and faceted. The average size of primary alumina crystals was about 3 micrometers as determined by the line intercept method. The microstructure between the primary alumina crystals was characteristic eutectic structure with no discernable cells.

Hardness was measured as described for Example 1, and was 11.7 GPa.

### EXAMPLE 4

Example 4 particles were prepared as described in Example 2, except the amounts of raw materials used were 80 grams of alumina particles (“Al6SG”), 20 grams of yttrium oxide particles (obtained from Molycorp, Inc.), 1 gram of methyl cellulose (Methocel A4M, obtained from Dow Chemical), 100 grams of water, and 200 grams of alumina milling media (cylindrical shape, both height and diameter of 0.635 cm; 99.9% alumina; obtained from Coors).

The flame formed particles were spherical in shape and varied in size from about 210 micrometer up to about 300 micrometer, with a mean particle size of about 250 micrometer.

The crystalline phase content of the Example 4 material was determined by XRD as described in Example 1. The crystalline phases identified for the Example 4 material were YAG;, and alpha-Al₂O₃ phases.

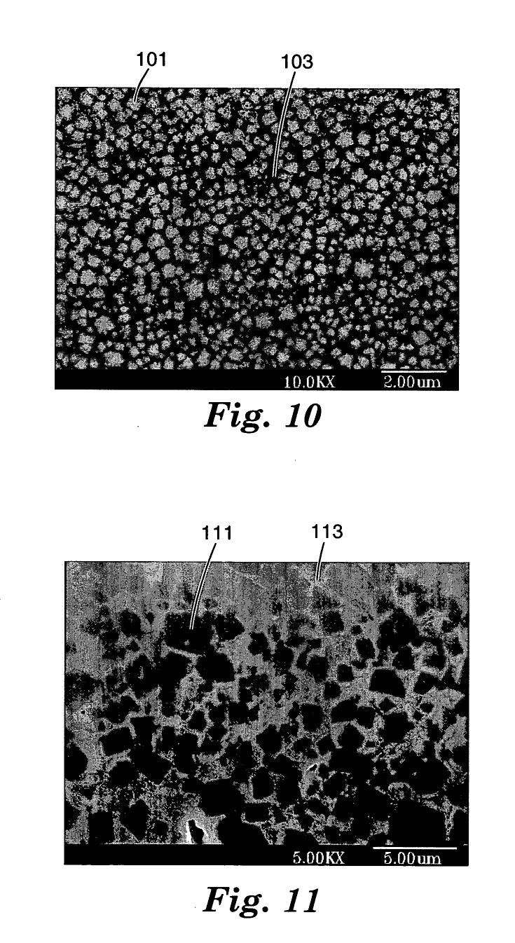

The microstructure of the Example 4 material was analyzed using the SEM as described in Example 1. FIG. 11 is a scanning electron microscope (SEM) electronphotomicrograph of a polished section of Example 4 material. The microstructure of the material was observed to be made up of primary crystals of Al₂O₃ 111 in a eutectic matrix 113 comprising YAG and alumina. The primary alumina crystals were equiaxed, and faceted. The average size of primary alumina crystals was about 4 micrometers as determined by the line intercept method. The microstructure between the primary alumina crystals was characteristic eutectic structure with no discernable cells.

Hardness was measured as described for Example 1, and was 13.2 GPa.

### EXAMPLE 5

Example 5 particles were prepared as described in Example 2, except the amounts of raw materials used were 95 grams of alumina particles (“Al6SG”), 5 grams of silicon dioxide particles (obtained from Alfa-Aesar, Ward Hill, Mass.), 1 gram of methyl cellulose (Methocel A4M, obtained from Dow Chemical), 100 grams of water and 200 grams of alumina milling media (cylindrical shape, both height and diameter of 0.635 cm; 99.9% alumina; obtained from Coors). For the flame forming, the feed particles had sizes in the range −80+100 mesh (i.e., the fraction collected between 150 micrometers opening size and 180 micrometers opening size screens, with a mean particle size of about 165 micrometer). The flame formed particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 5 material was determined by XRD as described in Example 1. The crystalline phases identified for the Example 5 material were a mixture of alpha and gamma-Al₂O₃ phases.

The microstructure of the Example 5 particles was analyzed using the SEM as described in Example 1. The microstructure of the material was observed to be made up of faceted alumina crystals. The average size of the alumina crystals was determined by using the line intercept method and was about 3 micrometers.

Hardness was measured as described for Example 1, and was 12.3 GPa.

### EXAMPLE 6

Examples 6 particles were prepared as described in Example 5, except the amounts of raw materials used were 95 grams of alumina particles (“Al6SG”), 5 grams of magnesium hydroxide particles (obtained from BDH Chemicals Ltd., Poole, England), 1 gram of methyl cellulose (Methocel A4M, obtained from Dow Chemical), 100 grams of water, and 200 grams of alumina milling media (cylindrical shape, both height and diameter of 0.635 cm; 99.9% alumina; obtained from Coors).

The flame formed particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 6 material was determined by XRD as described in Example 1. The crystalline phases identified for the Example 6 material were a mixture of alpha and gamma-Al₂O₃ and magnesium aluminum oxide (i.e., spinel) crystal phases.

The microstructure of the Example 6 material was analyzed using the SEM as described in Example 1. The microstructure of the material was observed to be made up of aluminum oxide and magnesium aluminum spinel crystals. The average crystal size for both crystal populations were determined by the line intercept method described for Example 1. Average size of the alumina crystals was 2 micrometers.

The average hardness of the Example 6 material was determined as described in Example 1. The average microhardness of the Example 6 material was 11.4 GPa.

### EXAMPLE 7

Examples 7 particles were prepared as described in Example 5, except the amounts of raw materials used were 100 grams of alumina particles (“Al6SG”), 100 grams of water and 200 grams of alumina milling media (cylindrical shape, both height and diameter of 0.635 cm; 99.9% alumina; obtained from Coors).

The flame formed particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 7 material was determined by XRD as described in Example 1. The crystalline phases identified for the Example 7 material were a mixture of alpha and gamma-Al₂O₃ crystal phases.

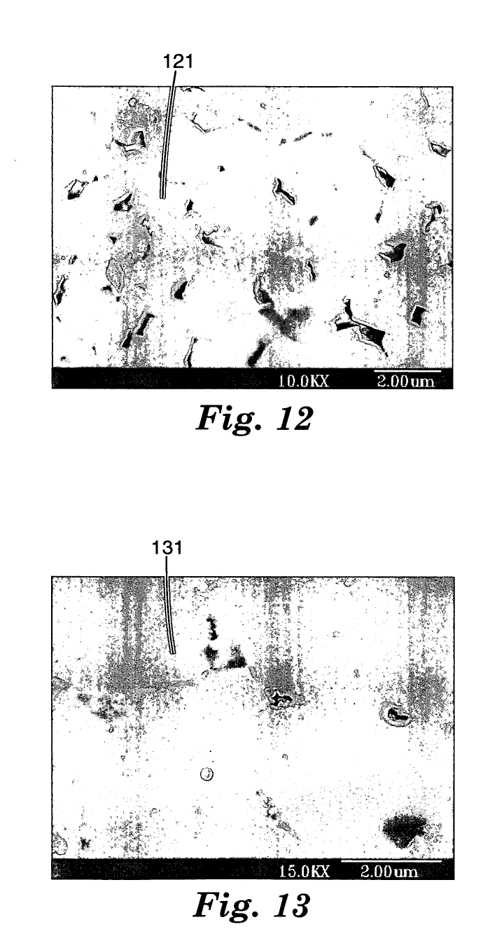

The microstructure of the Example 7 material was analyzed using the SEM as described in Example 1. FIG. 12 is a scanning electron microscope (SEM) electronphotomicrograph of a polished section of Example 7 material. The microstructure of the material was observed to be made up of Al₂O₃ crystals 121. Average size of the alumina crystals was 2 micrometers.

The average hardness of the Example 7 material was determined as described in Example 1. The average microhardness of the Example 7 material was 16.7 GPa.

### EXAMPLE 8

Sintered alumina, grade 36, abrasive grit (obtained from Treibacher Co., Austria under trade designation “ALUMINUM OXIDE CCC”) was crushed using steel crushers and screened to retain the −80+100 mesh fraction (i.e., the fraction collected between 180 micrometers opening size and 150 micrometers opening size screens, with a mean particle size of about 165 micrometer). The resulting screened particles were molten and quenched in a flame-former as described in Example 1.

The flame formed particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 8 material was determined by XRD as described in Example 1. The crystalline phases identified for the Example 8 material were a mixture of alpha and gamma-Al₂O₃.

The microstructure of the Example 8 material was analyzed using the SEM as described in Example 1. The microstructure of the material was observed to be made up of alumina crystals. Trace amounts of a second phase was present at the crystal boundaries, which is believed to contain iron contamination from the crushing step. The average crystal size was determined by the line intercept method described for Example 1. Average size of the alumina crystals was 3 micrometers.

The average hardness of the Example 8 material was determined as described in Example 1. The average microhardness was 12.3 GPa.

### EXAMPLE 9

Example 9 was prepared in the same manner as in Example 8 except the molten particles were air quenched. The distance from the burner to the collection container (the flame length) was 104 cm. The flame formed particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 9 material was determined by XRD as described in Example 1. The resulting crystalline phases identified for the Example 9 material were a mixture of alpha and gamma-Al₂O₃.

The microstructure of the Example 9 material was analyzed using the SEM as described in Example 1. FIG. 13 is a scanning electron microscope (SEM) electronphotomicrograph of a polished section of Example 9 material. The microstructure of the material was observed to be made up of Al₂O₃ crystals 131. Size of the alumina crystals ranged from 5 micrometers to 10 micrometers. Trace amount of a second phase was present at the crystal boundaries, which is believed to contain iron contamination from the crushing step.

### EXAMPLE 10

Example 10 was prepared in the same manner as in Example 8 except the molten particles were quenched using steel rollers. Each of the rollers were 4 cm in diameter. The two rollers were separated from each other by a gap (0.5 millimeter). The bottom halves of the rollers not facing the flame were immersed in water to keep the rollers cool. The flame formed particles were spherical in shape and varied in size from 100 micrometers up to 180 micrometer, with a mean particle size of about 145 micrometer, and were predominantly opaque (>90% by number; determined as described in Example 1), indicating their crystalline nature.

The crystalline phase content of the Example 10 particles was determined by XRD as described in Example 1. The resulting crystalline phases identified for the Example 10 material were a mixture of alpha and gamma-Al₂O₃.

The microstructure of the Example 10 particles was analyzed using the SEM as described in Example 1. FIG. 14 is a scanning electron microscope (SEM) electronphotomicrograph of a polished section of Example 10 material. The microstructure of the material was observed to be made up of Al₂O₃ crystals 141. Size of the alumina crystals ranged from 2 micrometer to 5 micrometers. Trace amount of a second phase was present at the crystal boundaries, which is believed to contain iron contamination from the crushing step.

### EXAMPLE 11

Example 11 was the same as Example 8 except that the feed particles were sol-gel-derived crystalline ceramic particles (1.5% by weight MgO, 1.5 by weight La₂O₃, 1.5 by weight Y₂O₃, and the remainder Al₂O₃; marketed by 3M Company, St. Paul, Minn. under the trade designation “CUBITRON 321”).

The flame formed particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 11 material was determined by XRD as described in Example 1. The resulting crystalline phases identified for the Example 11 material were a mixture of alpha and trace amounts of gamma-Al₂O₃, and Al₂O₃.REO phases.

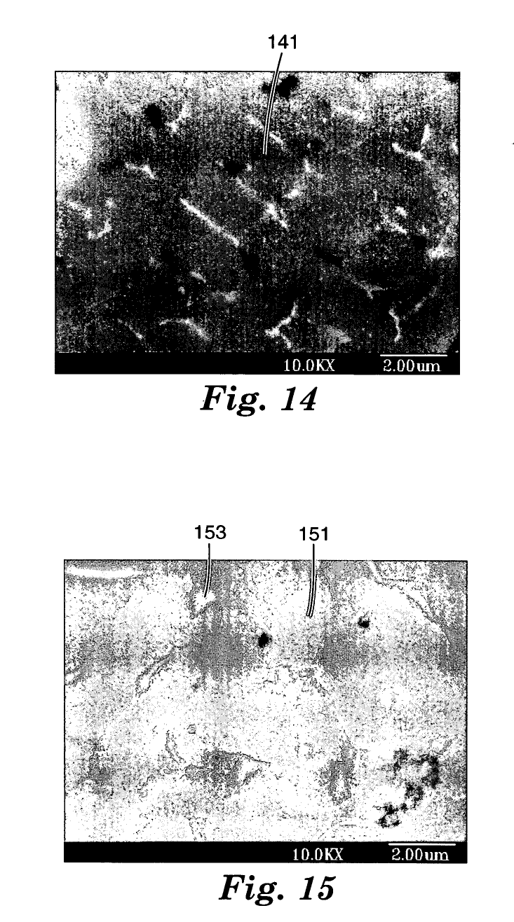

The microstructure of the Example 11 material was analyzed using the SEM as described in Example 1. FIG. 15 is a scanning electron microscope (SEM) electronphotomicrograph of a polished section of Example 11 material. The microstructure of the material was observed to be made up of Al₂O₃ crystals 151. Size of the alumina crystals ranged from 2 micrometers to 6 micrometers. The REO containing phases 153 formed a layer around the Al₂O₃ crystals.

### EXAMPLE 12

A 250-ml polyethylene bottle (7.3-cm diameter) was charged with 90 grams aluminum oxide powder (“Al6SG”), 5 grams of silicon dioxide powder (average particle size 3-4 micrometer, obtained from Alfa-Aesar, Bond Hill, Mass.), 25 grams of sodium zirconium lactate in water (obtained under the trade designation “TYZOR 217” from DuPont Chemicals, Wilmington, Del.), 100 grams of water and 200 grams of alumina milling media (cylindrical shape, both height and diameter of 0.635 cm; 99.9% alumina; obtained from Coors). The contents of the polyethylene bottle were milled for 16 hours at 60 revolutions per minute (rpm). After the milling, the milling media were removed and the slurry was poured onto a warm (about 75° C.) glass (“PYREX”) pan in a layer, and allowed to dry in an oven at 110° C. Due to the relatively thin layer of the material (i.e., about 3 mm think) of slurry and the warm pan, the slurry formed a cake within 5 minutes and dried in about 30 minutes. The dried mixture was ground by screening through a 30-mesh screen (600-micrometer opening size) with the aid of a paintbrush. The ground mixture was graded to retain the −80+100 mesh fraction (i.e., the fraction collected between 180 micrometers opening size and 150 micrometers opening size screens, with a mean particle size of about 165 micrometer). The resulting screened particles were fed slowly (about 0.5 gram/minute) through a funnel, which was attached to a powder feeder, under a nitrogen gas atmosphere 5 standard liter per minute (SLPM), into a hydrogen/oxygen torch flame which melted the particles and carried them directly into a 19-liter (5-gallon) rectangular container (41 centimeters (cm) by 53 cm by 18 cm height) of continuously circulating, turbulent water (20° C.) to rapidly quench the molten droplets. The powder feeder comprised a canister (8 cm diameter) at the bottom of which was a 70-mesh screen (212 micrometer opening size). The powder was filled into the canister and was forced through the openings of the screen using a rotating brush as described in Example 1. The torch was a Bethlehem bench burner PM2D Model B obtained from Bethlehem Apparatus Co., Hellertown, Pa. The torch had a central feed port (4.75 millimeter, 3/16 inch, inner diameter) through which the feed particles were introduced into the flame. Hydrogen and oxygen flow rates for the torch were as follows. The hydrogen flow rate was 42 standard liters per minute (SLPM) and the oxygen flow rate was 18 SLPM. The angle at which the flame hit the water was approximately 90°, and the flame length, burner to water surface, was approximately 38 centimeters (cm). The resulting (quenched) particles were collected in a pan and heated at 110° C. in an electrically heated furnace till dried (about 30 minutes). The particles were spherical in shape and varied in size from 100 micrometers up to 180 micrometers, with a mean particle size of about 145 micrometer, and were predominantly opaque (>90% by number; determined as described in Example 1), indicating their crystalline nature.

The crystalline phase content of the Example 12 material was determined by powder XRD as described in Example 1. The crystalline phases determined for the Example 12 material were a mixture of alpha and gamma-Al₂O₃ and tetragonal/cubic zirconia crystal phases.

The microstructure of the Example 8 material was analyzed using the SEM as described in Example 1. The microstructure of the material was observed to be made up of aluminum oxide crystals. A zirconia containing layer was present around the alumina crystals. Average size of the alumina crystals was 2-3 micrometers.

The average hardness of the Example 12 material was determined as described in Example 1. The average microhardness was 15.2 GPa.

Various modifications and alterations of this invention will become apparent to those skilled in the art without departing from the scope and spirit of this invention, and it should be understood that this invention is not to be unduly limited to the illustrative embodiments set forth herein.

1. A method of making a plurality of fused, polycrystalline ceramic abrasive particles having a specified nominal grade, the method comprising:
melting a first plurality of particles to form melt droplets, wherein the first plurality of particles collectively provide at least 35 percent by weight Al₂O₃ collectively in the melt droplets, based on the total weight of the melt droplets, wherein the melt droplets collectively have a first composition;
cooling the melt droplets to directly provide a second plurality of particles, wherein the second plurality of particles collectively have a second composition, wherein the second composition is in a range from 75 to 125 percent by weight of the first composition, wherein at least 75 percent by number of the second plurality of particles are fused, polycrystalline ceramic abrasive particles, with the proviso that if the fused, polycrystalline ceramic abrasive particles include eutectic microstructure, such fused, polycrystalline ceramic abrasive particles also include at least one complex Al₂O₃.metal oxide, and wherein the fused, polycrystalline ceramic abrasive particles comprising at least 35 percent by weight Al₂O₃, based on the total weight of the respective fused, polycrystalline ceramic abrasive particle; and
grading the fused, polycrystalline ceramic abrasive particles to provide the plurality of abrasive particles having a specified nominal grade.

2. The method according to claim 1, wherein at least a portion of the first plurality of particles are glass particles.

3. The method according to claim 1, wherein at least a portion of cooling the melt comprises immersing the melt in water.

4. The method according to claim 1, wherein the melt and the fused, polycrystalline ceramic abrasive particles comprise at least 50 percent by weight Al₂O₃, based on the total weight of the melt or respective fused, polycrystalline ceramic abrasive particle, respectively.

5. The method according to claim 1, wherein the melt and the fused, polycrystalline ceramic abrasive particles comprise at least 75 percent by weight Al₂O₃, based on the total weight of the melt or respective fused, polycrystalline ceramic abrasive particle, respectively.

6. The method according to claim 1, wherein the melt and the fused, polycrystalline ceramic abrasive particles comprise at least 90 percent by weight Al₂O₃, based on the total weight of the melt or respective fused, polycrystalline ceramic abrasive particle, respectively.

7. The method according to claim 1, wherein the melt and the fused, polycrystalline ceramic abrasive particles comprise at least 95 percent by weight Al₂O₃, based on the total weight of the melt or respective fused, polycrystalline ceramic abrasive particle, respectively.

8. The method according to claim 1, wherein at least 50 percent by volume of the first plurality of particles have particle sizes less than 1000 micrometers.

9. The method according to claim 1, wherein at least 75 percent by volume of the first plurality of particles have particle sizes less than 1000 micrometers.

10. The method according to claim 1, wherein at least 90 percent by volume of the first plurality of particles have particle sizes less than 1000 micrometers.

11. The method according to claim 1, wherein melting is conducted via flame forming.

12. The method according to claim 1, wherein melting is conducted via plasma spraying.

13. The method according to claim 1, wherein the fused, polycrystalline ceramic abrasive particles have an average hardness of at least 12 GPa.

14. The method according to claim 1, wherein the fused, polycrystalline ceramic abrasive particles have in average hardness of at least 15 GPa.

15. The method according to claim 1, wherein the fused, polycrystalline ceramic abrasive particles have an average hardness of at least 17 GPa.

16. The method according to claim 1, wherein the specified nominal grade is at least one of an ANSI, FEPA, or JIS standard.

17. The method according to claim 16, further comprising incorporating the graded fused, polycrystalline ceramic abrasive particles into an abrasive article.

18. The method according to claim 1 further comprising incorporating a portion of the fused, polycrystalline ceramic abrasive particles into an abrasive article.

19. The method according to claim 1 further comprising crushing the fused, polycrystalline ceramic abrasive particles prior to the grading.

20. The method according to claim 1, wherein the melt is at least partially cooled by contacting rollers.

21. The method according to claim 20, wherein the rollers arc immersed in water.

22. A method of making a abrasive article, the method comprising:
melting a first plurality of particles to form melt droplets, wherein the first plurality of particles collectively provide at least 35 percent by weight Al₂O₃ collectively in the melt droplets, based on the total weight of the melt droplets, wherein the melt droplets collectively comprise a first composition;
cooling the melt droplets to directly provide a second plurality of particles, wherein the second plurality of particles collectively have a second composition, wherein the second composition is in a range from 75 to 125 percent by weight of the first composition, wherein at least 75 percent by number of the second plurality of particles are fused, polycrystalline ceramic abrasive particles, with the proviso that if the fused, polycrystalline ceramic abrasive particles include eutectic microstructure, such fused, polycrystalline ceramic abrasive particles also include at least one complex Al₂O₃.metal oxide, and wherein the fused, polycrystalline ceramic abrasive particles comprising at least 35 percent by weight Al₂O₃, based on the total weight of the respective fused, polycrystalline ceramic abrasive particle; and
combining at least a portion of the fused, polycrystalline ceramic abrasive particles with binder to provide the abrasive article.

23. The method according to claim 22, wherein at least a portion of the first plurality of particles are glass particles.

24. The method according to claim 22, wherein at least a portion of cooling the melt comprises immersing the melt into water.

25. The method according to claim 22, wherein the melt and the fused, polycrystalline ceramic abrasive particles comprise at least 50 percent by weight Al₂O₃, based on the total weight of the melt or respective fused, polycrystalline ceramic abrasive particle, respectively.

26. The method according to claim 22, wherein the melt and the fused, polycrystalline ceramic abrasive particles comprise at least 75 percent by weight Al₂O, based on the total weight of the melt or respective fused, polycrystalline ceramic abrasive particle, respectively.

27. The method according to claim 22, wherein at least 50 percent by volume of the first plurality of particles have particle sizes less than 1000 micrometers.

28. The method according to claim 22, wherein melting is conducted via flame forming.

29. The method according to claim 22, wherein the fused, polycrystalline ceramic abrasive particles have in average hardness of at least 15 GPa.

30. The method according to claim 22, wherein the melt is at least partially cooled by contacting rollers.

31. The method according to claim 30, wherein the rollers are immersed in water.

32. A method of making a plurality of abrasive particles having a specified nominal grade, the method comprising:
melting raw materials to provide a melt, wherein the melt comprises at least 35 percent by weight Al₂O₃, based on the total weight of the melt, wherein the melt has a first composition;
cooling the melt to directly provide fused, polycrystalline material having have a second composition, wherein the second composition is in a range from 75 to 125 percent by weight of the first composition, and wherein the fused, polycrystalline material comprising at least 35 percent by weight Al₂O₃, based on the total weight of the fused, polycrystalline material;
crushing the fused, polycrystalline material to provide fused, polycrystalline ceramic abrasive particles comprising at least 35 percent by weight Al₂O₃, based on the total weight of the respective fused, polycrystalline ceramic abrasive particle; and
grading the fused, polycrystalline ceramic abrasive particles to provide the plurality of abrasive particles having a specified nominal grade.

33. The method according to claim 32, wherein at least a portion of the raw materials are glass.

34. The method according to claim 32, wherein at least a portion of cooling the melt comprises immersing the melt in water.

35. The method according to claim 32, wherein the melt and the fused, polycrystalline ceramic abrasive particles comprise at least 50 percent by weight Al₂O₃, based on the total weight of the melt or respective fused, polycrystalline ceramic abrasive particle, respectively.

36. The method according to claim 32, wherein the melt and the fused, polycrystalline ceramic abrasive particles comprise at least 75 percent by weight Al₂O₃, based on the total weight of the melt or respective fused, polycrystalline ceramic abrasive particle, respectively.

37. The method according to claim 32, wherein the melt and the fused, polycrystalline ceramic abrasive particles comprise at least 90 percent by weight Al₂O₃, based on the total weight of the melt or respective fused, polycrystalline ceramic abrasive particle, respectively.

38. The method according to claim 32, wherein the melt and the fused, polycrystalline ceramic abrasive particles comprise at least 95 percent by weight Al₂O₃, based on the total weight of the melt or respective fused, polycrystalline ceramic abrasive particle, respectively.

39. The method according to claim 32, wherein melting is conducted via flame forming.

40. The method according to claim 32, wherein melting is conducted via plasma spraying.

41. The method according to claim 32, wherein the fused, polycrystalline ceramic abrasive particles have an average hardness of at least 12 GPa.

42. The method according to claim 32, wherein the fused, polycrystalline ceramic abrasive particles have an average hardness of at least 15 GPa.

43. The method according to claim 32, wherein the fused, polycrystalline ceramic abrasive particles have an average hardness of at least 17 GPa.

44. The method according to claim 32, wherein the specified nominal grade is at least one of an ANSI, FEPA, or JIS standard.

45. The method according to claim 32, further comprising incorporating a portion of the fused, polycrystalline ceramic abrasive particles into an abrasive article.

46. The method according to claim 32, wherein the melt is at least partially cooled by contacting rollers.

47. The method according to claim 46, wherein the rollers are immersed in water.

48. A method of making an abrasive article, the method comprising:
melting raw materials to provide a melt, wherein the melt comprises at least 35 percent by weight Al₂O₃, based on the total weight of the melt, wherein the melt has a first composition;
cooling the melt to directly provide fused, polycrystalline material having have a second composition, wherein the second composition is in a range from 75 to 125 percent by weight of the first composition, and wherein the fused, polycrystalline material comprising at least 35 percent by weight Al₂O₃, based on the total weight of the fused, polycrystalline material;
crushing the fused, polycrystalline material to provide fused, polycrystalline ceramic abrasive particles comprising at least 35 percent by weight Al₂O₃, based on the total weight of the respective fused, polycrystalline ceramic abrasive particle; and
combining at least a portion of the fused, polycrystalline ceramic abrasive particles with binder to provide the abrasive article.

49. The method according to claim 48, wherein at least a portion of the raw materials are glass.

50. The method according to claim 48, wherein at least a portion of cooling the melt comprises immersing the melt into water.

51. The method according to claim 48, wherein the melt and the fused, polycrystalline ceramic abrasive particles comprise at least 50 percent by weight Al₂O₃, based on the total weight of the melt or respective fused, polycrystalline ceramic abrasive particle, respectively.

52. The method according to claim 48, wherein the melt and the fused, polycrystalline ceramic abrasive particles comprise at least 75 percent by weight Al₂O₃, based on the total weight of the melt or respective fused, polycrystalline ceramic abrasive particle, respectively.

53. The method according to claim 48, wherein the melt and the fused, polycrystalline ceramic abrasive particles comprise at least 90 percent by weight Al₂O₃, based on the total weight of the melt or respective fused, polycrystalline ceramic abrasive particle, respectively.

54. The method according to claim 48, wherein the melt and the fused, polycrystalline ceramic abrasive particles comprise at least 95 percent by weight Al₂O₃, based on the total weight of the melt or respective fused, polycrystalline ceramic abrasive particle, respectively.

55. The method according to claim 48, wherein melting is conducted via flame forming.

56. The method according to claim 48, wherein melting is conducted via plasma spraying.

57. The method according to claim 48, wherein the fused, polycrystalline ceramic abrasive particles have an average hardness of at least 12 GPa.

58. The method according to claim 48, wherein the fused, polycrystalline ceramic abrasive particles have an average hardness of at least 15 GPa.

59. The method according to claim 48, wherein the fused, polycrystalline ceramic abrasive particles have an average hardness of at least 17 GPa.

60. The method according to claim 48, wherein the melt is at least partially cooled by contacting rollers.

61. The method according to claim 60, wherein the rollers are immersed in water.
